(19) United States
(12) Patent Application Publication
(10) Pub. No.: US 2021/0067350 A1
(43) Pub. Date: Mar. 4, 2021

(54) PRESENCE AND IDENTITY VERIFICATION USING WIRELESS TAGS

(71) Applicant: Adero, Inc., Goleta, CA (US)

(72) Inventors: Michael G. McClintock, Santa Barbara, CA (US); Adrian Yanes, Santa Barbara, CA (US); Jack Shen, Goleta, CA (US); Nathan Kelly, Santa Barbara, CA (US); Jeremiah Prousalis, Santa Barbara, CA (US); Paul Horenberger, Santa Barbara, CA (US); David Wagner, Santa Barbara, CA (US); Seth Robin, Santa Barbara, CA (US)

(21) Appl. No.: 16/560,464

(22) Filed: Sep. 4, 2019

(51) Int. Cl. H04L 9/32; G06Q 50/30

(52) U.S. Cl. CPC H04L 9/3268; H04L 9/3213; G06Q 50/30

(57) ABSTRACT

A method includes: receiving, in a first tag, a first security certificate for a second tag and a session token corresponding to an arrangement involving the first and second tags; determining, by the first tag, that the second tag satisfies a proximity criterion with regard to the first tag; receiving, in the first tag and from the second tag, the first security certificate and the session token; and generating, by the first tag and in response to the determination and the receipt of the first security certificate and the session token, a first output corresponding to verification of a custodian of the second tag as a participant in the arrangement.

### CROSS-REFERENCE TO RELATED APPLICATIONS

This patent application relates to the following pending patent applications (“the related patent applications”):

U.S. patent application Ser. No. 16/183,079, filed Nov. 7, 2018, and entitled “Organizing physical objects using wireless tags.”

U.S. patent application Ser. No. 16/183,087, filed Nov. 7, 2018, and entitled “Organizing groups of physical objects using wireless tags.”

U.S. patent application Ser. No. 16/183,092, filed Nov. 7, 2018, and entitled “Providing indication to location of physical object using wireless tag.”

U.S. patent application Ser. No. 16/183,097, filed Nov. 7, 2018, and entitled “Tag for wirelessly organizing a physical object.”

The disclosure of each one of the related patent applications is incorporated herein by reference in its entirety.

### TECHNICAL FIELD

This document relates, generally, to presence and identity verification using wireless tags.

### BACKGROUND

In today's world, online to offline (O2O) services are becoming more prevalent. O2O services agreed upon through a digital platform and the services are rendered offline. O2O services can include ordering a dog walker through an online platform, where the dog walking service is provided in the real world; ordering a cleaning service; ordering a ride sharing service; or ordering food delivery, to name just a few examples. Other kinds of O2O situations exist that do not involve a service. For example, dating apps or other matchmaking tools serve to connect participants to each other in an online context for subsequent meetings offline.

### SUMMARY

In a first aspect, a method includes: receiving, in a first tag, a first security certificate for a second tag and a session token corresponding to an arrangement involving the first and second tags; determining, by the first tag, that the second tag satisfies a proximity criterion with regard to the first tag; receiving, in the first tag and from the second tag, the first security certificate and the session token; and generating, by the first tag and in response to the determination and the receipt of the first security certificate and the session token, a first output corresponding to verification of a custodian of the second tag as a participant in the arrangement.

Implementations can include any or all of the following features. Receiving the first security certificate and the session token from the second tag comprises: receiving, by the first tag and from the second tag, an encrypted communication; decrypting, by the first tag, the encrypted communication using the first security certificate; and determining, by the first tag, that the encrypted communication includes the session token. The first security certificate is received from an arrangement broker system. A first person associated with the first tag makes the arrangement using an online interface provided by the arrangement broker system. The arrangement broker system provides the first security certificate and the session token to the first tag upon the arrangement being made. The method further comprises providing, by the first tag and to the arrangement broker system, a second security certificate for the first tag. The arrangement broker system comprises a service broker system. The arrangement comprises that a first person associated with the first tag makes a reservation for an O2O service using an online interface provided by the arrangement broker system. The O2O service includes a rideshare arrangement where a second person associated with the second tag is to use a vehicle to transport the first person. The method further comprises determining, by the first tag and after generating the first output, that the second tag no longer satisfies the proximity criterion with regard to the first tag without the O2O service being complete, and in response generating a second output. The method further comprises verifying, by the first tag, a passenger that is in the vehicle when the first security certificate and the session token are received. Verifying the passenger comprises: receiving, by the first tag and from the service broker system, a first passenger token; receiving, by the first tag and in association with receiving the first security certificate and the session token, a second passenger token from a third tag; and determining, by the first tag, a correspondence between the first passenger token and the second passenger token. The method further comprises providing, by the first tag and after receiving the first security certificate and the session token, the session token to the arrangement broker system. A multifactor authentication is performed, the multifactor authentication comprising: receiving, by the first tag and in association with the arrangement being made, a first authentication token from the arrangement broker system; receiving, by the first tag and in association with receiving the first security certificate and the session token, a second authentication token from a third tag; and determining, by the first tag, a correspondence between the first authentication token and the second authentication token. The arrangement involves a rideshare service in which the third tag is carried by a vehicle. The second authentication token is native to the vehicle. The second authentication token is specific to the rideshare service and was provided to the vehicle by the arrangement broker system. The method further comprises generating, by the first tag, a communication to the second tag that confirms the arrangement. The session token includes a secured, single-use, digitally signed token. The arrangement includes that a second person associated with the second tag is to enter premises of a first person, a lock to the premises associated with the first tag. The method further comprises a pre-authorization process comprising: the first security certificate being received by a device carried by the first person; and the first tag receiving the first security certificate from the device. Receipt of the first security certificate by the device occurs in a first context when the device does not have online access, and wherein receipt of the first security certificate by the first tag occurs in a second context when the device does have the online access.

In a second aspect, a computer program product is tangibly embodied in a non-transitory storage medium, the computer program product including instructions that when executed cause a processor to perform operations, the operations comprising: receiving, in a first tag, a first security certificate for a second tag and a session token corresponding to an arrangement involving the first and second tags; determining, by the first tag, that the second tag satisfies a proximity criterion with regard to the first tag; receiving, in the first tag and from the second tag, the first security certificate and the session token; and generating, by the first tag and in response to the determination and the receipt of the first security certificate and the session token, a first output corresponding to verification of a custodian of the second tag as a participant in the arrangement.

In a third aspect, a method includes: receiving, in an arrangement broker system and from a first tag associated with a first person, a first security certificate for the first tag, the first security certificate received in association with an arrangement involving the first person; identifying, by the arrangement broker system, a second tag associated with a second person also involved with the arrangement; generating, by the arrangement broker system, a session token for the arrangement; and providing, by the arrangement broker system and to the second tag, the first security certificate and the session token.

Implementations can include the following feature. The method further comprises receiving, by the arrangement broker system and from at least one of the first tag or the second tag, a communication that includes the session token.

### BRIEF DESCRIPTION OF DRAWINGS

FIG. 1 schematically shows an example operating environment in which a system can track physical items.

FIG. 2 shows a block diagram of an example of a tag.

FIG. 3 shows an example of an activity component and a rules repository.

FIG. 4 shows an example of a record that can be generated to track presence, proximity, and movement of physical items.

FIG. 5 shows an example of a record that can be generated to track presence, proximity, and movement of physical items.

FIG. 6 shows an example of a record that can be generated to track presence, proximity, and movement of physical items.

FIGS. 7A-F show examples relating to presence and identity verification.

FIGS. 8A-E show examples relating to a rideshare arrangement.

FIG. 9 shows another example relating to a rideshare arrangement.

FIG. 10 shows an example relating to presence and identity verification regarding premises.

FIGS. 11-13 show examples of methods relating to presence and identity verification.

FIGS. 14A-F show examples relating to presence and identity verification.

FIGS. 15A-D show other examples relating to presence and identity verification regarding premises.

FIGS. 16A-F show examples relating to presence and identity verification.

FIGS. 17A-B show other examples relating to presence and identity verification regarding an item.

FIG. 18 shows an example of a computer device that can be used to implement the techniques described here.

Like reference symbols in the various drawings indicate like elements.

### DETAILED DESCRIPTION

This document includes examples of systems and techniques for verifying presence and identification using one or more wireless tags. Implementations can provide presence and identity verification between people, physical objects, and/or locations, in space via signal processing of one or more radio-frequency (RF) fields generated from wireless tags to determine relationships for purposes of contactless authentication, permissions, access, and/or process automation. In some implementations, a process can be provided to verify the identities between two or more people as a contemplated arrangement (e.g., an agreed upon service or encounter) is about to occur (e.g., the service is about to be rendered or the encounter is about to take place) based on proximity. Examples include, but are not limited to, a dog walker or delivery worker arriving at a customer's door, a rideshare driver arriving to pick up a passenger, or participants who were connected with each other online agree to meet in person. If all parties present are authorized, a positive indicator can be communicated to both parties for safety reasons. Conversely, if one or more of the parties is not recognized to have an authorized relationship with the other, a warning can be issued to one or more parties.

Some examples herein relate to O2O services. In previous approaches for delivering O2O services, the business model typically does not include true verification of the identity of the offline service provider to match the identity that was agreed upon in the online platform. For example, no verification process may be performed to verify that the actual dog walker, food deliverer, or rideshare driver is the authorized service provider that has been sent by the service brokerage company. Ridesharing is sometimes referred to as peer-to-peer ridesharing (or a similar term) and can be used in O2O and/or in non-O2O scenarios. For example, ridesharing can be directly or indirectly organized by a transportation network company (e.g., that provides one or more apps useable by drivers or passengers). There have been incidents reported of offline service providers that claim to be the authorized service provider, when they are in fact not, which may create liability for the service providing company and a dangerous environment for the customer. Today (in a rideshare example), the safety precaution responsibility for person-person identity verification lies with the customer and requires them to visually or manually assess the service provider (usually through their name, a profile picture, or a license plate number). This process is subjective and may not be verifiable or reliable. Another approach for verification includes performing an approximation the two parties (e.g., customer and service provider) through their global positioning system (GPS) locations to estimate whether or not a service is in process or rendered. This process may not be accurate or truly verifiable, for example in cities or areas with limited line of sight to GPS satellites.

Some examples herein relate to O2O arrangements. In previous approaches for arranging O2O encounters (e.g., based on an online tool), the arrangement typically does not include true verification of the identity of the participant(s) to match the identity that was agreed upon in the online platform.

Some existing approaches have sought to provide authentication of a person with regard to a building or other premises. User badges is an example of such an approach that has been used for more complex properties (complex in terms of variety of users, or number of users). Examples of badges include hotel room access (e.g., hotel room key cards), office access (e.g., access fobs), home (e.g., protection tags). However, each access point requires dedicated hardware and the solution is only effective in exact proximity to an entrance point, not beyond. Such approaches may not provide optimal flexibility, and/or may not provide hands-free environments. Another example of a previous approach is smart locks and smart security systems. However, existing smart locks and security systems do not take action based on context (e.g., including time of day, who is home, who is arriving, or of any relationships to existing or prior events, users, or similarity to previously observed actions) and may require a manual command from the user to lock/unlock or arm/disarm.

This disclosure describes examples of systems and techniques that automate presence verification and authorization between people, objects, and/or locations in the physical world. This can be done via a combination of signal processing of RF field properties generated from wireless tags and a secured protocol using single-use authentication tokens that are digitally signed utilizing cryptography. This authentication process can be automatically triggered upon the recognition or detection of one RF signal in the presence or proximity of another RF signal. When in proximity, a secured exchange of secure tokens through encrypted and digitally signed messages can be performed to verify the identity of one or more of the participating wireless tags, thereby verifying the identity of its corresponding person, object, or location. In some implementations, this authentication process can be independent across applications, separate from an application layer and integrated in lower layers such as transport and link, not relying on any user interaction.

In the example of a person-person authentication within a rideshare driver and passenger example, as the driver approaches the passenger within certain range of proximity, a secured single-use digitally signed token may be automatically generated by a tag belonging to the driver (such as the driver's phone), and delivered to the expectant customer for verification. For example, the verification is done by a tag that can be worn in a pocket of one's clothing or in form of a wearable device or jewelry, which further enhances the advantage of a contactless interaction that can be almost entirely transparent to the user.

Upon recognition of this automated interaction between participants, if the verification of identity and the relationship of each participant is confirmed, the parties can receive an acknowledgement of positive confirmation that this is an authorized or permitted interaction. Conversely, if the identity or interaction is not confirmed, one or more parties, including the rideshare service company, may receive a negative confirmation that this interaction has not been authorized. A further verification process may also be introduced in this specific example, where the identity of the vehicle can also participate in the automated authorization process. The vehicle itself, or a wireless device representing the vehicle (such as the vehicle's onboard Bluetooth radio, a verified wireless accessory, or an on-board diagnostics (OBD) wireless device), can verify the identity of the vehicle and participate in authorizing the interaction between the driver, passenger, and the vehicle. As a driver approaches a passenger, the wireless tags registered to and identifying the driver and the vehicle may enter the wireless range of the wireless tags registered to and identifying the passenger. Signal processing of the RF fields between each respective field may determine proximity for purposes of authorization or verification of this interaction. For example, this can be done through exchange of messages that may be encrypted and securely signed. Such an automated process may confirm the identities of each participant, thereby ensuring that the interaction is indeed between the parties that were arranged through the ridesharing platform. For example, this can increase the safety and validity of both driver and passenger.

In an example relating to verification that only authorized persons are entering a location, such as a building or a room, or are authorized to be in a location, one or more wireless tags belonging to a person or issued to a person can be verified to ensure the identity of that person. For example, this can be done through exchange of secure messages between the person's tag and a tag of the location, building, or room. In some implementations, a requirement can be imposed that additional or multiple wireless devices be present that each independently may verify that person's identity. In some implementations, requiring the presence of two or more people (with or without the requirement for additional wireless devices per person) can be used to strengthen the security for a location. In any scenario, the strength of security can be increased or decreased based on additional context such as time of day (e.g., additional security may be required at night), day of the week (e.g., additional security may be required during the weekend), or amount of foot traffic to a location (e.g., additional security may be required due to a high volume of visitors to a location).

Implementations may leverage existing wireless device to authenticate a person, object, or location. Improved secure or verified interactions can be achieved without necessarily involving dedicated, single purpose devices such as RFID tags or readers. As another example, a wireless tag can continuously provide information beyond an entrance point of premises such as a building. This may provide a continuous, passive, and contactless (from a user-action perspective) authorization confirmation process to authenticate permission of persons entering a location, being within a location, or being nearby a location. For example, such process can be used in open environments such as apartment complexes, educational campuses, commercial centers, and/or enterprise or industrial workspaces.

In some implementations, an authorization process can be achieved in a contactless manner, without any concurrent user-driven actions. For example, this can be done based on the presence, proximity, and location of the interaction between tags that are involved in the authorization process. A contactless authentication process between persons, locations, and/or physical objects may be advantageous in hands-free environments such as sterile operating rooms of a hospital or use cases that are prohibitive of manual interactions (e.g., a construction site where workers have their hands full, or a rideshare scenario where a passenger is managing his or her luggage).

As used herein, a tag is a wireless device with processing capability and configured to be attached to, embedded in, or otherwise coupled to a physical object to facilitate organizing or tracking of at least the presence, proximity, and movement of that physical object. The tag can include a wireless communication component that serves to transmit data packets over wireless (e.g., radio) signals from time to time (e.g., as a beacon), or to receive data packets over the signal(s) from another tag and/or from a processing device. Examples of tags that can be configured to facilitate organization or tracking of at least the presence, proximity, and movement of a physical object include, but are not limited to, a smartphone, a handheld device, a connected door lock, an Internet of Things (IoT) device, a wireless display device for a rideshare vehicle, or a wireless pet tag.

The tag may include processing components to facilitate its communication with other parts of the system. The tag may be provided with context that is relevant to the tag and/or its physical object, and/or for surrounding tags and/or objects. In some implementations, such additional context may be provided through queries to other tags, devices, aspects of the system; input responses from one or more users; sensors or detection of environmental aspects, changes or variations of activity occurring such as presence or absence of expected/unexpected devices, anticipated or unanticipated occurring events or activities, or state changes in the devices internal awareness, or the duration of any number of such example activities. For example, the context and the tag's processing capability may allow the tag to phrase, or formulate responses to, queries including, but not limited to: What is the identity of the custodian of the tag? Which person(s) is the custodian expected to, or required to, or not allowed to, be near. Which person(s) is or are expected to, or required to, or not allowed to, be near the custodian? Where is the tag located? To which premises (e.g., real property, building, and/or room) is the tag assigned? Which person(s) is or are expected to, or required to, or not allowed to, be near the premises?

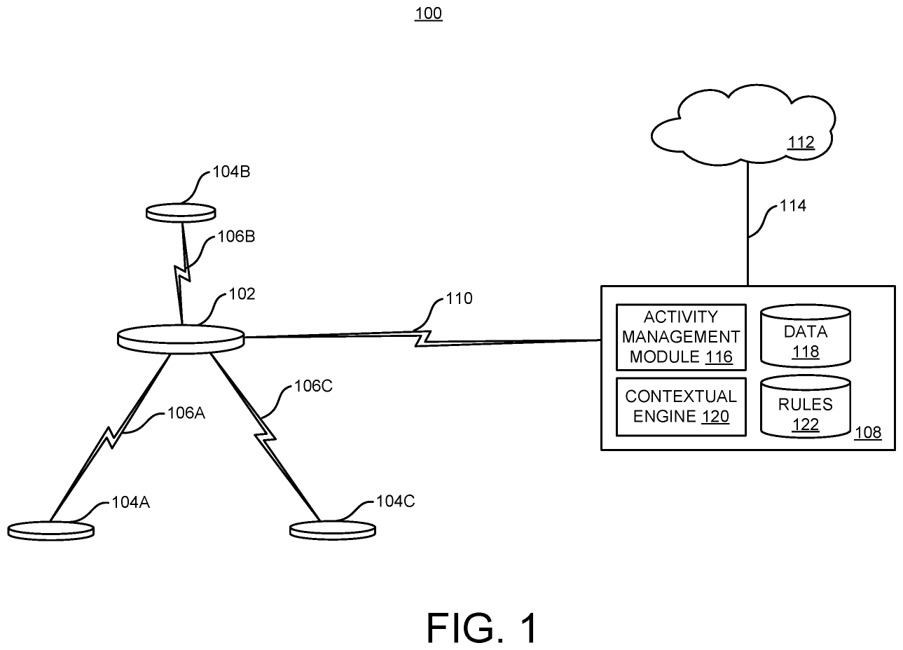

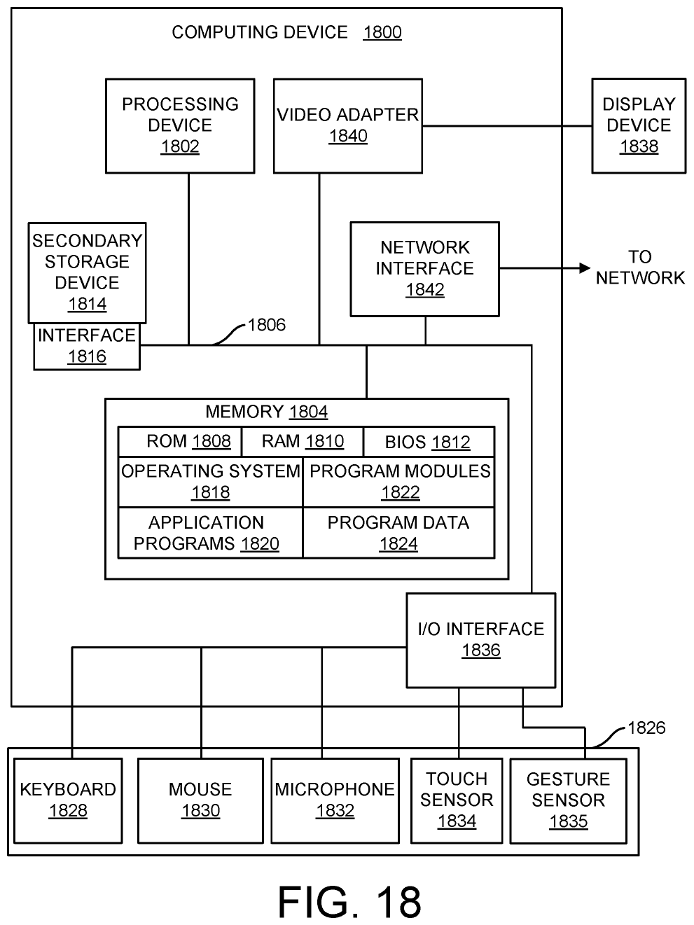

FIG. 1 schematically shows an example operating environment in which a system 100 can track physical items. The system 100 can be used with one or more other examples described elsewhere herein. The system 100 can be implemented using one or more examples described herein with reference to FIG. 18.

The system 100 includes at least one tag 102 and/or at least one tag 104A-C. In some implementations, multiple instances (i.e., a plurality) of the tag 102 can be used, and here only one instance of the tag 102 is shown for simplicity. The tags 102 and 104A-C can be configured to be attached to, mounted on, or otherwise coupled to, respective physical objects which are not shown for simplicity. For example, the tag 102 may be attached to a sports bag and tags 104A-C may be attached to a baseball glove, a baseball cap, and a bat, respectively. Communication between the tag 102 and one or more of the tags 104A-C may occur by way of sending data packets over respective wireless signals 106A-C. In some implementations, the wireless signals 106A-C include beacon signals and the tag 102 is configured for receiving and recognizing the wireless signals 106A-C. For example, the tag 102 can be considered a parent tag with regard to one or more of the tags 104A-C. As another example, one or more of the tags 104A-C can be considered a child tag with regard to the tag 102. In some implementations, at least one instance of the tag 102 can serve as a child tag to another instance of the tag 102. In some implementations, at least one instance of the tag 104A can serve as a child tag to another instance of the tag 104A. In this example, the tag 102 can be considered to be at a first level of a hierarchy (e.g., as a parent tag), and the tags 104A-C can be considered to be at a second level of the hierarchy (e.g., as child tags). In some implementations, more levels than two can be used in a hierarchy.

For example, each of the tags 104A-C can be assigned to an item that a person carries in their purse to serve as a tracker for that item, and the tag 102 can be defined to correspond to the purse itself, to facilitate organizing and performance of actions based on whether the group of the tags 104A-C represented by the tag 102 is presently intact, or whether one or more of the tags 104A-C is deemed not to be within the group.

The system 100 includes a processing device 108 that can be implemented using one or more examples described with reference to FIG. 18. In some implementations, the processing device 108 may be implemented by one or more processors executing instructions stored in one or more instances of computer-readable storage medium. For example, a processor can execute instructions stored in a memory to instantiate and operate the processing device 108. Communication between the tag 102 and the processing device 108 can occur by way of at least one wireless signal 110. In some implementations, one or more of the tags 104A-C can communicate directly with the processing device 108.

The processing device 108 can be implemented as a single physical component, or can be distributed over multiple physical components. In some implementations, the processing device 108 may include a mobile electronic device (e.g., a smartphone, tablet, watch, wearable device, and/or laptop). In some implementations, the processing device 108 may include a dedicated stand-alone device (e.g., a hub in the system 100).

The processing device 108 can communicate directly and/or via a network with one or more other components within the system 100, outside the system 100, or both. In some implementations, the processing device 108 may participate in group management (e.g., of the tag 102 and/or the tags 104A-C), notification management (e.g., to a user by way of the tag 102 and/or tags 104A-C, or another user interface, such as the display device 1838 in FIG. 18), software updates (e.g., of the tag 102 and/or the tags 104A-C), power management (e.g., of the tag 102 and/or the tags 104A-C), and/or artificial intelligence (e.g., to control the tag 102 and/or the tags 104A-C, and/or to control responses to scenarios involving it or them).

The system 100 can include or make use of one or more remote processing devices, here referred to as clouds 112. The cloud 112 can be implemented using one or more examples described with reference to FIG. 18. Communication between the processing device 108 and the cloud 112 may occur by way of at least one signal 114. The signal 114 can be a wireless signal and/or a wired signal and here schematically illustrates a data network connection between devices. The signal 114 can be sent through one or more networks, including, but not limited to, a local network and/or the internet. In some implementations, the processing device 108 or components thereof can be implemented at least in part by the cloud 112. In some implementations, the tag 102 and/or at least one of the tags 104A-C can communicate directly with the cloud 112.

Activity can be monitored and managed in the system 100. Activity can include, but is not limited to, one or more aspects of presence, proximity, movement, or concentration, and/or the duration of any such presence, proximity, movement, or concentration. Activity monitoring and management in the system 100 can occur by way of the processing device 108 and/or the cloud 112. Here, an activity management module 116 is shown as part of the processing device 108 for purpose of illustration only. The activity management module 116 can accumulate data 118 to facilitate and/or in performing such activity management. For example, the data 118 is stored in a computer-readable medium. For example, data can be stored as state variables on a processing device.

The system 100 can be configured according to one or more levels. In some implementations, the processing device 108 and at least the tag 102 can be considered an item level in the system 100. For example, the item level can facilitate system awareness of at least the presence, proximity and movement of the physical item(s) associated with the tag(s) 102. In some implementations, a group level in the system 100 can include the item level just mentioned and one or more of the tags 104A-C. For example, the group level can facilitate that the tag 102 serves as the parent of the tag(s) 104A-C and monitors the at least the presence, proximity and movement of the physical item(s) associated with the tag(s) 104A-C. In some implementations, a home level in the system 100 can include the group level just mentioned and one or more connected components, including, but not limited to a hub in the system 100, a router, a digital assistant, and/or a smart lightbulb. For example, the home level can provide and manage awareness about the presence, proximity and movement of the physical item(s) associated with the tag(s) 102 and/or the tag(s) 104A-C in a broader spatial environment, such as in a home, office or other location. In some implementations, a system intelligence level in the system 100 can include the home level just mentioned and one or more cloud services. For example, the cloud service(s) can provide contextual notification based on the presence, proximity or movement recognized within the home level. As another example, the cloud service(s) can provide predictive ability based on data recognized in the system 100 and/or tracked behavior relating to the system 100 and/or the physical objects associated with the tags 102 and/or 104A-C.

Contextualization in the system 100 can occur by way of the processing device 108 and/or the cloud 112. Here, a contextual engine 120 is shown as part of the processing device 108 for purpose of illustration only. The contextual engine 120 can harvest data from one or more sources (e.g., based on detecting the behavior of a nearby device) and use it for contextualization, prediction, and/or to adapt its behavior. Harvested data can include external data, such as calendar information for event data, weather data for weather conditions, or crowd-based data, to name just a few examples. Data can be harvested in one or more ways. In some implementations, each device maintains a state table with various state information about the system. For example, as each device determines a change in the information, the device may update the data in the local state variable and then send the new data to the other devices in the system so that each device maintains a current view of the system.

In some implementations, contextualization can include collection of standardized data from one or more entities in the system 100 (e.g., ultimately from the tag 102 and/or the tags 104A-C), collection of disparate device data (e.g., data that is unexpected or otherwise does not conform to a data standard), and/or performance of system dictated actions (e.g., issuing a notification, modifying a behavior, redistributing one or more system resources). Contextualization can be related to or facilitated by the invocation of one or more rules 122 in the system 100. Solely as illustrative examples, the rule(s) 122 can define, with regard to the tag 102 and/or the tag(s) 104A-C, one or more locations where presence is permitted, required, or is not permitted; one or more objects or persons with which a certain proximity is permitted, required, or is not permitted, one or more characteristics of movement that is permitted, required, or is not permitted; and/or one or more concentrations that is permitted, required, or is not permitted. The rule(s) 122 can specify actions performable by the system 100 under specific circumstances (e.g., to generate a notification or to energize or de-energize a component). For example, the rules 122 are stored in a computer-readable medium.

Contextualization can be based on one or more aspects of environmental understanding. In some implementations, an environmental understanding can include information or input that can be processed (e.g., weather conditions, time-based information, information extracted from a calendar, location, presence and/or activity). For example, notification that one of the tags 104A-C is not currently present in the group represented by the tag 102 can be conditioned on some aspect of the weather information (e.g., whether precipitation is forecast).

Contextualization can lead to a contextual understanding that can be the basis for performing (or deciding not to perform) one or more actions in the system 100. The performance of (or abstention from taking) of an action can be predicated on the identity of at least one person and a recognition that the person is (or is not) present at a particular location, as indicated by one or more tags of the system 100. The contextual understanding can facilitate phrasing of, or formulation of responses to, queries along the lines of those exemplified above regarding tags. For example, such queries and/or responses can relate to verification of an object or of the identity of a person, and verification whether the object or person is authorized to be at a specific location at a certain time.

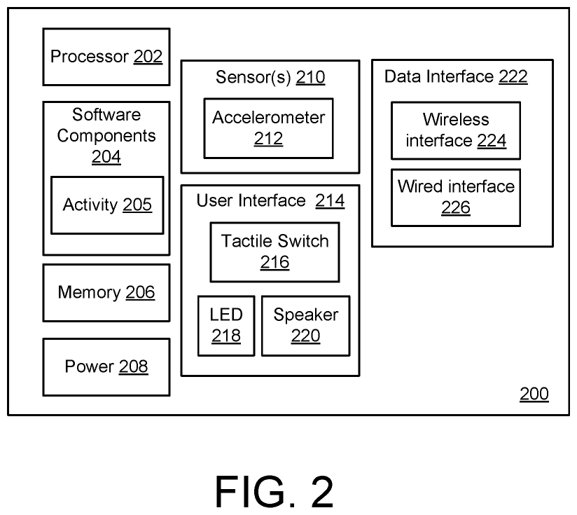

FIG. 2 shows a block diagram of an example of a tag 200. The tag 200 can be implemented using one or more examples described with reference to FIG. 18. The tag 200 can be implemented substantially inside a housing that facilitates attachment of the tag 200 to, or otherwise coupling the tag 200 with, a physical object. For example, the housing can include one or more enclosures serving to contain at least some of the components of the tag 200 as a cohesive unit. The tag 102 and/or the tags 104A-C can be implemented using the tag 200. Solely as an example, and without limitation, such housing can have a thickness that is on the order of a few mm, and or a greatest width in any dimension that is on the order of tens of mm. For example, the housing can be an essentially circular disc. An identifier (e.g., a QR code) can be affixed to the housing to aid in identification and/or a setup process.

The tag 200 can be attached to, embedded within, or otherwise coupled to the physical object in one or more ways. For example, the tag 200 can be provided with an adhesive on the housing that couples to a surface on the physical object. As another example, the tag 200 can be provided with a holder that attaches to the tag 200, the holder having a loop (e.g., a keyring) for being coupled to the physical object.

The tag 200 can include at least one processor 202. The processor 202 can be semiconductor-based and can include at least one circuit that performs operations at least in part based on executing instructions. The processor 202 can be a general-purpose processor or a special-purpose processor.

The tag 200 can include one or more software components 204. The software components 204 can include software (e.g., firmware). In some implementations, the software components 204 includes an activity component 205 that can control one or more aspects of operation by the tag 200. For example, the activity component 205 can include some or all functionality described with reference to the activity management module 116 (FIG. 1) or the contextual engine 120. The software components 204 can be formulated using one or more programming languages that facilitate generation of instructions comprehensible to the processor 202.

The tag 200 can include at least one memory 206. The memory 206 can store information within the tag 200. The memory 206 can be implemented in the form of one or more discrete units. The memory 206 can include volatile memory, non-volatile memory, or combinations thereof.

The tag 200 can include a power supply 208. The power supply 208 can power some or all of the components of the tag 200 or other components not shown. In some implementations, the power supply 208 includes one or more electrochemical cells (e.g., a lithium-ion cell) capable of storing energy in chemical form and allowing consumption of that energy by way of conversion into electrical current. In some implementations, the power supply 208 includes a capacitor capable of storing energy in an electric field. The power supply 208 can be rechargeable (e.g., by external power from a voltage/current source, or from a solar cell) or non-rechargeable. For example, the power supply 208 can be recharged by electrically connecting a power source to physical pins that contact the power supply 208. As another example, the power supply 208 can be recharged wirelessly (e.g., by inductive charging). Kinetic energy harvesting and/or thermal energy harvesting may be used. In some implementations, a near-field communication (NFC) coil can also be used as a charging coil for inductive charging. For example, the power supply 208 can be recharged wirelessly in near proximity (e.g., by inductive coupled charging using internal dedicated coil or reusing an NFC coil for charging). As another example, the power supply 208 can be recharged wirelessly in far field (e.g., by electric field charging) or using energy harvesting techniques from multiple ambient sources, including kinetic or bio-mechanical sources (e.g., a piezo electric generator sensing vibration or thermo-electric generator (TEG) which harvests energy from temperature gradient). In some implementations, ambient backscatter energy may be used to power the tag directly (e.g., in lieu of using an electrochemical cell to store energy).

The tag 200 can include one or more sensors 210. The sensor(s) 210 can be configured to detect one or more characteristics of the environment or other surrounding to which the tag 200 is subjected. The sensor(s) 210 can detect one or more aspects including, but not limited to, moisture, humidity, temperature, pressure, altitude, acoustics, wind speed, strain, shear, magnetic field strength and/or orientation, electric field strength and/or orientation, electromagnetic radiation, particle radiation, compass point direction, a fingerprint or other biometric characteristic, or acceleration. Here, for example, the sensor 210 includes an accelerometer 212. For example, the accelerometer 212 may be used to detect if the tag 200 is in motion, and the processor 202 of the tag 200 may decide to change the behavior of the tag 200 based on the motion detected. For example, the beaconing pattern of the wireless interface 224 may be increased when the tag 200 is determined to be moving. Collection of data (e.g., one or more signals) from the sensor(s) 210 can be considered harvesting of information that can be the basis for deterministic behavior, predictive behavior, and/or adaptive behavior in the system in which the tag 200 is implemented.

The tag 200 may include one or more user interfaces 214. The user interface(s) 214 can facilitate one or more ways that a user can make input to the tag 200 and/or one or more ways that the tag 200 can make output to a user. In some implementations, the user interface 214 includes a tactile switch 216. For example, activating the tactile switch can open and close an electric circuit on the tag 200, thus providing input to the tag 200. In some implementations, the user interface 214 includes at least one light-emitting diode (LED) 218. The LED 218 can illuminate using one or more colors to signal a status of the tag 200 or of another tag, and/or to convey an instruction to the user. A red-blue-green LED can be used for the LED 218. In some implementations, the LED 218 can indicate power and/or pairing status during setup of the tag 200. In some implementations, the LED 218 can confirm the presence or absence of one or more child tags. In some implementations, the user interface 214 includes at least one speaker 220. The speaker 220 can emit one or more portions of audio to signal a status of the tag 200 or of another tag, and/or to convey an instruction to the user. For example, the speaker 220 can include an audio piezo buzzer.

The tag 200 may include at least one data interface 222. Here, the data interface 222 is shown as including a wireless interface 224 and a wired interface 226. The data interface 222 can facilitate communication between the tag 200 and at least one component in a system, such as during operation or a software update. For example, the data interface 222 can facilitate the wireless signal 110 (FIG. 1) between the tag 102 and the processing device 108. As another example, the data interface 222 can facilitate one or more of the wireless signals 106A-C between the tag 102 and the tags 104A-C. In some implementations, the data interface 222 can be configured for short-distance communications (e.g., in a personal-area or near-me network). In some implementations, the data interface 222 can be also or instead be configured for longer-distance communications (e.g., in a local-area or wide-area network). For example, and without limitation, the data interface 222 can operate in accordance with the principles of one or more of Bluetooth communication, Bluetooth Low Energy (BLE) communication, Zigbee communication, Wi-Fi communication, Long-Term Evolution (LTE) communication, NFC, Long Range (LoRa) communication, ultra wide band (UWB) communication, radio-frequency identification (RFID) communication, Ethernet, Ethernet over powerline, or Narrow-Band (NB).

The data interface 222 (e.g., the wired interface 226) can make use of physical pins on the tag 200. In some implementations, the physical pins at least partially extend beyond the hull of a housing that contains the tag 200 so that the physical pins can be contacted by another component. In some implementations, the physical pins relating to the data interface 222 can be grouped with physical pins relating to the power supply 208 (e.g., to be used in recharging). For example, the physical pins relating to the data interface 222 can be used to trigger the tag 200 to be ready to receive electrical input on the physical pins relating to the power supply 208.

The tag 200 can include at least one bus or other communication component that facilitates communication between two or more of the processor 202, software components 204, memory 206, sensor(s) 210, user interface 214, and/or data interface 222.

The tag 200 can be implemented as an intelligent device that can be used for personal tracking and organization. The tag 200 can be configured to communicate directly (or indirectly, such as via a network) with one or more instances of the tag 200, such as with a child tag when the tag 200 is considered a parent tag, or with a parent tag when the tag 200 is considered a child tag. The tag 200 can be configured for direct/indirect communication with a processing device (e.g., the processing device 108 in FIG. 1, a third-party IoT device, and/or a cloud server (e.g., the cloud 112 in FIG. 1). The tag 200 can be configured to generate and record state information. For example, the tag 200 can record events that relate to the tag 200 and/or to another tag. The tag 200 can represent a single object (e.g., the physical object to which the tag 200 is attached) or a group of objects (e.g., the physical objects to which respective child tags are attached when the tag 200 is considered a parent tag). The tag 200 can be configured to have one or more relationships with another instance of the tag 200, with a person (e.g., an owner or user), and/or with a location. For example, such relationships can be defined in the rules 122 (FIG. 1).

The tag 200 can be used to organize essentials (e.g., physical objects of significance) and for personal organization. The tag 200 can help a user quickly locate the physical object to which the tag 200 is attached. The tag 200 can serve as a parent tag for one or more child tags (e.g., instances of the tag 200) within a group solution, which can allow for tracking of the presence, proximity, and movement of other physical objects. The tag 200 can serve as a location marker. For example, this can be exploited by a location service designed to provide indications to the location of wireless-enabled devices.

Examples herein mention that a tag can serve as a child tag to another tag, which can be considered the parent tag. In some implementations, the child tag is implemented with all components of the tag 200, optionally with more components. In some implementations, the child tag can have fewer than all of the components of the tag 200. For example, the power supply 208 in the child tag may be non-rechargeable. As another example, the child tag may not have one or more of the sensor(s) 210 (e.g., the accelerometer 212 can be omitted). As another example, the LED 218 in the child tag can be a single-color LED (e.g., white). As another example, the child tag may not have the speaker 220. As another example, the child tag may not have the wired interface 226. For example, no physical data pins may be present on the housing of the child tag.

In operation, the child tag (e.g., including some or all of the components of the tag 200) can be used to organize a range of physical objects, including all everyday essentials that a person may have. The parent tag (e.g., including some or all of the components of the tag 200) can monitor the child tag(s) to which it is connected. As such, the parent tag can indicate the presence of a physical object to which the child tag is attached/coupled based on the child tag's proximity to the parent tag. For example, the parent tag can send a message indicating whether the child tag is within the range of the parent tag or not within the range of the parent tag.

Examples herein illustrate that a tag (e.g., the tag 200) can have an awareness of circumstances. Aspects of the awareness can be categorized as being either internal or external. An internal awareness may pertain to the physical object itself. In some implementations, the internal awareness can be further separated into preset state values and dynamic state values. Preset state values can include, but are not limited to, make, model, manufacturing date, unique identifier (UID), device info, object type, or manufacturer's suggested retail price (MSRP). Dynamic state values can include, but are not limited to, battery level, power consumption, market value, directive, beaconing rate, communications frequency, communications protocol, object relationship logic, owner identity, permissions, internal clock, motion, or orientation.

An external awareness can relate to factors externally related to the physical object. External factors can include, but are not limited to, relative location, geo location, time, sensor data, objects nearby, proximity, relative motion of objects nearby, or duration of any states.

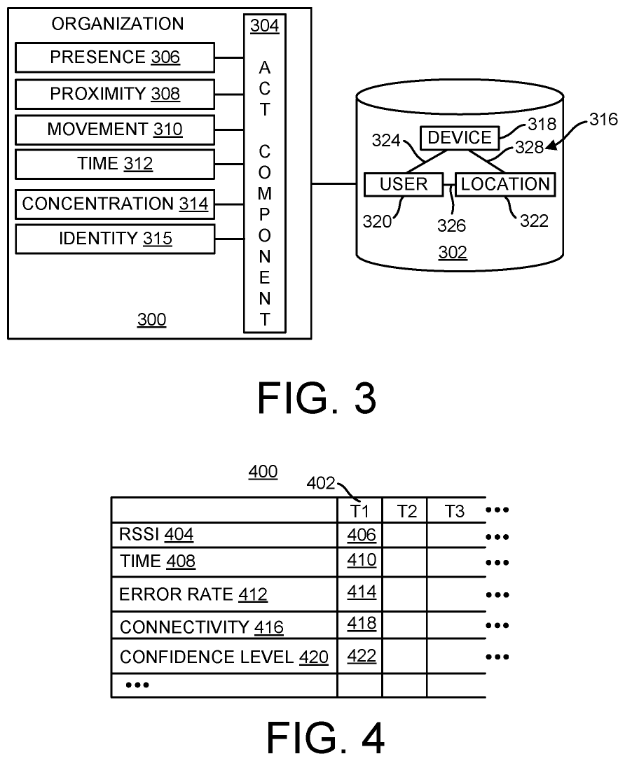

FIG. 3 shows an example of an organization module 300 and a rules repository 302. The organization module 300 and the rules repository 302 can be used with one or more other examples described elsewhere herein. The organization module 300 and the rules repository 302 can be implemented using one or more examples described with reference to FIG. 18. For example, the organization module 300 can be implemented by way of at least one processor executing instructions stored in a computer-readable medium. The rules in the rules repository 302 can relate to relationships including, but not limited to, permissions, groupings, and/or parent-child hierarchies.

The organization module 300 can be implemented in a device such as the tag 200 (FIG. 2), the tags 102 and/or 104A-C (FIG. 1), or in the processing device 108 (FIG. 1), to name just a few examples. Such device(s) can receive wireless signals from one or more items being monitored. For example, the tag 102 when serving as a parent tag can receive the wireless signals 106A-C from the tags 104A-C, respectively, serving as child tags. As another example, the processing device 108 can receive the wireless signal 110 from the tag 102.

The organization module 300 can use the received signal(s) to gain insight into at least the presence, proximity, or movement of the transmitting device, or of a device related to the transmitting device. In some implementations, received signal strength indication (RSSI) can be used as part of such a determination. The RSSI can indicate the power present in the received signal (e.g., the wireless signals 106A-C or the wireless signal 110). In some implementations, relative RSSI can be used. Generally speaking, when the transmitting device is closer to the receiving device, the RSSI tends to be greater because there is more power in the received signal.

The organization module 300 can detect “activity” of a tag, processing device, and/or a third-party IoT device, in any of several senses, including, but not limited to, that the device is present in a system, that the device is proximate to something (e.g., another device, a tag, an object, or a user, according to a proximity measure), and/or that the device is moving, and the organization module 300 can take action if appropriate. The organization module 300 can also or instead detect the “inactivity” of a device and take action if appropriate. As such, the organization module 300 may not merely detect, or respond to, a device's action.

In some implementations, activity can be detected or determined in one or more ways. For example, a tag can send a message when the tag senses (e.g., by an accelerometer) that it is moving. As another example, a first tag can detect that a second tag is moving because the RSSI is decreasing in a predictable manner. As another example, a first tag can detect that a second tag is moving because the RSSI is decreasing and a third tag reports increasing RSSI with the second tag.

In some implementations, time (e.g., duration) can be part of such a determination of activity. In some implementations, a transmitting device may include a timestamp or other time identifier in the transmitted message, and the receiving device can compare the timestamp/identifier with its (internal) clock to determine an amount of time that passed between the sending and the receipt of the wireless signal. For example, the clocks in the transmitting and receiving devices can be synchronized to a master clock, or the receiving device may know how to translate the transmitting device's timestamp into its local time. Internal processing delays (at the transmitting or receiving end) can be accounted for. As another example, the time can be measured from the moment of sending a request for a response until the response is received. The time is a measure of the latency experienced in communication between two devices (e.g., two tags, a parent tag and a child tag, and/or a tag and a processing device). A latency value can be defined based on the time it takes for a signal to reach the receiver. The latency value, moreover, can be used to characterize the distance between the transmitting and receiving devices, which gives an indication as to the relative position of the devices. In some implementations, time may be measured with round trip time (RTT) for estimating distance. For example: the sender sends a message, and based on the time it takes to receive a response, the sender can infer things about link quality and distance. RTT can be used to give information about packet loss, error rate, or number of hops (in the case of a mesh search).

In some implementations, connectivity can be part of such a determination. In some implementations, connectivity can represent whether a device (e.g., a parent tag) is able to communicate with another device (e.g., a child tag). For example, a connectivity parameter can be a binary factor dependent on whether communication is currently established between two devices.

The activity A can also or instead take into account one or more other characteristics. For example, latency can be taken into account (e.g., denoted by L). For example, packet error rate can be taken into account (e.g., denoted by PER). For example, packet loss can be taken into account (e.g., denoted by PL). For example, change in RSSI over time can be taken into account (e.g., denoted by ΔRSSI). For example, change in connectivity over time can be taken into account (e.g., denoted by ΔC). For example, change in latency over time can be taken into account (e.g., denoted by ΔL). For example, change in packet error rate over time can be taken into account (e.g., denoted by ΔPER). For example, change in packet loss over time can be taken into account (e.g., denoted by ΔPL). In some implementations, the activity A can be based on one or more of RSSI, C, L, PER, PL, ΔRSSI, ΔC, ΔL, ΔPER, or ΔPL.

As such, a proximity metric for the distance between devices (e.g., two tags, a parent tag and a child tag, and/or a tag and a processing device) can be defined based on one or more of RSSI, C, L, PER, PL, ΔRSSI, ΔC, ΔL, ΔPER, or Δ, for example as shown for A above. This can be considered a proximity measure that the organization module 300 can use in determining the presence, proximity, and movement of one or more tags. The proximity measure takes into account at least one of RSSI, C, L, PER, PL, ΔRSSI, ΔC, ΔL, ΔPER, or ΔPL, and can optionally take into account also one or more other parameters. The organization module 300 can include an activity (ACT) component 304 that can be responsible for determining and providing a proximity measure (e.g., based on A above). In some implementations, the activity component 205 (FIG. 2) can include one or more aspects of functionality described with reference to the activity component 304.

The organization module 300 can include one or more components that facilitate use of a proximity measure in determining, and reacting to, the activity of one or more tags. In some implementations, the organization module 300 includes a presence component 306 coupled to the activity component 304. For example, the presence component 306 can make use of the proximity measure of the activity component 304 to determine the presence of a tag (e.g., whether the tag 104A (FIG. 1) serving as a child tag is present relative to the tag 102 serving as a parent tag for the tag 104A). As another example, a tag can be deemed present if it is detected by the system, whether the tag is proximate to another tag (e.g., its parent tag) or not. The determination of whether a tag is present can depend on the rules in the rules repository 302, and as such can be different for different physical objects. For example, a wallet labeled with a tag can be deemed present if it is detected as being inside the dwelling of the person who owns the wallet; a wheelbarrow, on the other hand, can be deemed to be present if it is detected by either the system monitoring the owner's house or the corresponding system at the neighbor's house, in that the neighbor may be permitted to borrow the wheelbarrow from the owner's yard.

In some implementations, the organization module 300 includes a proximity component 308 coupled to the activity component 304. For example, the proximity component 308 can make use of the proximity measure of the activity component 304 to determine the proximity of a tag (e.g., how proximate to the tag 104A (FIG. 1) serving as a child tag is relative to the tag 102 serving as a parent tag for the tag 104A).

In some implementations, the organization module 300 includes a movement component 310 coupled to the activity component 304. For example, the movement component 310 can make use of the proximity measure of the activity component 304 to determine the movement of a tag (e.g., how the tag 104A (FIG. 1) serving as a child tag moves relative to the tag 102 serving as a parent tag for the tag 104A).

In some implementations, the organization module 300 includes a time component 312 coupled to the activity component 304. For example, the time component 312 can make use of the proximity measure of the activity component 304 to determine a duration relating to a tag (e.g., how long the tag 104A (FIG. 1) serving as a child tag is present, proximate, and/or moving relative to the tag 102 serving as a parent tag for the tag 104A). As another example, a time as in the time of day at a particular location, can be a factor in applying a rule based on contextualized information.

In some implementations, the organization module 300 includes a concentration component 314 coupled to the activity component 304. For example, the concentration component 314 can make use of the proximity measure of the activity component 304 to determine a concentration of at least one tag (e.g., some or all of the tags 104A-C (FIG. 1) serving as child tags relative to the tag 102 serving as a parent tag for the tags 104A-C). For example, a concentration can be used to provide multi-factor authentication of a user. As another example, a concentration can be used to generate a heat map of a location (e.g., to aid a determination of what type of environment it is).

The activity component 304 can factor in a temporal component in the determination of a proximity measure. In some implementations, one of the rules in the rules repository 302 can define that an alert should be generated if one of the tags 104A-C (FIG. 1) is not present in the group represented by the tag 102. However, if, for example, the tag 104A had been detected as present within the group over an extended period of time and was not detected as undergoing (significant) movement at the time its signal was lost, the activity component 304 can apply a grace period (e.g., on the order of a few or multiple seconds) before generating the alert. For example, this temporal component (e.g., a grace period) can account for the situation where the signal 106A (FIG. 1) from the tag 104A was temporarily blocked and the absence of the signal 106A did not correspond to the tag 104A being missing from the group represented by the tag 102. Also, or instead, another component in the organization module 300 can apply the temporal component to a corresponding determination.

The organization module 300 can take into account contextualized information in determining the activity (e.g., presence, proximity, and/or movement) of any tag, in performing one or more actions in response thereto, or in deciding not to take action. In some implementations, the contextual engine 120 (FIG. 1) or a similar component can serve to contextualize harvested information so that the rules in the rules repository 302 can be applied appropriately.

The tags (e.g., the tag 102 and/or the tags 104A-C in FIG. 1) can be proxies for other devices, users, and/or locations. The rules in the rules repository 302 can reflect such an organization. In some implementations, a rule 316 can reflect one or more of a device 318, a user 320, or a location 322. Moreover, the rule 316 can involve a device-user relationship 324, a user-location relationship 326, and/or a device-location relationship 328. As such, any of a number of relationships can be taken into account when applying the rule(s) in the rules repository 302, and can be reflected in the particular action (or a non-action) taken in response.

As such, the contextual engine 120 in FIG. 1 is an example of a contextual engine implemented using a processor (e.g., the processing device 1802 in FIG. 18) executing instructions stored in a memory (e.g., the memory 1804 in FIG. 18), the contextual engine configured to identify an action relating to at least one tag of a plurality of tags (e.g., two or more of the tags 102 and/or 104A-C) based on a proximity measure (e.g., determined by the activity component 304) for the corresponding tag.

The rules 122 in FIG. 1 can be stored in a rules repository accessible to a contextual engine (e.g., to the at least one processor of the contextual engine 120 in FIG. 1), the rules repository having stored therein rules (e.g., the rule 316) regarding respective actions performable by the activity component (e.g., by the at least one processor of the organization module 300), the rules depending on the proximity measure (e.g., determined by the activity component 304) for the at least one of the first plurality of tags, the action identified using the rules.

The contextual engine 120 (FIG. 1) can run in any of multiple environments or contexts. In some implementations, the contextual engine 120 can run in a cloud (e.g., in the cloud 112 in FIG. 1). In some implementations, the contextual engine 120 can run in a processing device (e.g., in the processing device 108 in FIG. 1). The processing device 108 can be a mobile device (e.g., a user's smartphone or a tablet), and/or a substantially stationary device (e.g., a dedicated stand-alone device, which may be considered a hub in the system 100. In some implementations, the contextual engine 120 can run in a tag (e.g., in the tag 102 and/or one of the tags 104A-C in FIG. 1). The contextual engine 120 can operate based on the wireless presence-proximity-movement determination by the activity management module 116, and based on relationships, which can be defined in the rules 122 in FIG. 1, to determine one or more actions. For example, the contextual engine 120 can apply context based on relationships including, but not limited to, permissions (e.g., whether a physical object is allowed to be moving at a particular time), groupings (e.g., whether two or more physical objects are permitted to be proximate to (e.g., to a certain degree of proximity), or separated from, each other), parent-child hierarchies, and/or ownership and/or value of a physical object. Other inputs such as time and/or environmental conditions can be provided to the contextual engine 120.

The contextual engine 120 (FIG. 1) can include, or make use of, a component that makes use of artificial intelligence, machine learning, and/or predictive algorithms. This can allow the contextual engine 120 to observe behavior or other occurrences and adapt its behavior (or that of another component) accordingly. In some implementations, the learning can have a temporal component. For example, the contextual engine 120 can observe that a tag and/or its child tags usually are subject to substantial motion at a particular time of day (e.g., 7.30-8.00 a.m.). To avoid glitches in the way that personal belongings are monitored or managed, the contextual engine 120 can allow for more notifications at the observed time so as to provide more intensive coverage. As another example, the contextual engine 120 can reduce the amount of notifications so as to avoid false or redundant alerts.

The organization module 300 includes an identity component 315 coupled to the activity component 304. In some implementations, the activity component 304 can make use of the identity component 315 to determine whether at least one tag (e.g., the tag 102 and/or more of the tags 104A-C in FIG. 1) is authorized to be present near a person, near an object, and/or at a location. Such a determination can be performed with regard to a person that is about to perform an O2O service. In such a scenario, the presence and identity determination can include an evaluation whether a security certificate provided by a tag carried by the person corresponds to a security certificate provided in connection with making the reservation of the O2O service.

FIG. 4 shows an example of a record 400 that can be generated to track presence, proximity, and movement of physical items. The record 400 can be used with other examples described elsewhere herein. The record 400 can be generated by a device that monitors or otherwise tracks activities relating to one or more other devices, and can be persisted in a computer-readable storage medium. For example, the processing device 108 (FIG. 1) and/or at least one of the tags 102 or 104A-C can generate the record 400. For example, the record 400 can be stored in the memory 206 (FIG. 2) and/or in the memory 1804 (FIG. 18). Only a portion of the record 400 is here shown for simplicity.

The record 400 can include an identifier 402 for one or more tags. Here, the tags are labeled T1, T2, and T3, respectively, using the identifier 402. For example, the record 400 can be generated by a parent tag and the tags T1-T3 can be child tags of the parent tag.

The record 400 can include one or more information portions for each tag relating to at least the presence, proximity, or movement of that tag. Here, an RSSI measure 404 is included in the record 400. For example, a value 406 for the RSSI measure 404 can reflect a received signal strength indication for the tag T1. Here, a time measure 408 is included in the record 400. For example, a value 410 for the time measure 408 can reflect a time delay (e.g., a latency value) associated with the tag T1. Here, an error rate measure 412 is included in the record 400. For example, a value 414 for the error rate measure 412 can reflect the error rate for communications to or from the tag T1. In some implementations, a packet loss measure can be used instead of, or in combination with, the error rate measure 412. Here, a connectivity parameter 416 is included in the record 400. For example, a value 418 for the connectivity parameter 416 can reflect whether a connection with the tag T1 exists. Here, a confidence level parameter 420 is included in the record 400. For example, a value 422 for the confidence level parameter 420 can reflect a determined level of confidence that the tag T1 is currently within its defined group. Other measures or parameters not shown can be included in the record 400.

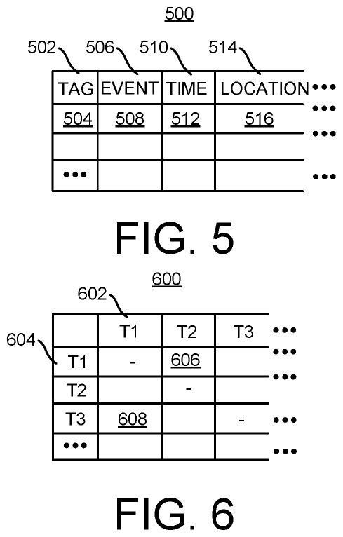

FIG. 5 shows an example of a record 500 that can be generated to track presence, proximity, and movement of physical items. The record 500 can be used with other examples described elsewhere herein. The record 500 can be generated by a device that monitors or otherwise tracks activities relating to one or more other devices, and can be persisted in a computer-readable storage medium. For example, the processing device 108 (FIG. 1) and/or at least one of the tags 102 or 104A-C can generate the record 500. Only a portion of the record 500 is here shown for simplicity.

The record 500 can include an identifier 502 for one or more tags. For example, a value 504 for the identifier 502 can identify any of the tags 102 or 104A-C in FIG. 1. The record 500 can include an event parameter 506. For example, a value 508 for the event parameter 506 can correspond to an event involving one or more of the tags 102 or 104A-C in FIG. 1, or the processing device 108. The record 500 can include a time parameter 510 for one or more tags. For example, a value 512 for the time parameter 510 can specify a time that the event was detected. The record 500 can include a location parameter 514 for one or more tags. For example, a value 516 for the location parameter 514 can specify a location at which the event is deemed to have taken place. Other measures or parameters not shown can be included in the record 500.

FIG. 6 shows an example of a record 600 that can be generated to track presence, proximity, and movement of physical items. The record 600 can be used with other examples described elsewhere herein. The record 600 can be generated by a device that monitors or otherwise tracks activities relating to one or more other devices, and can be persisted in a computer-readable storage medium. For example, the processing device 108 (FIG. 1) and/or at least one of the tags 102 or 104A-C can generate the record 600. Only a portion of the record 600 is here shown for simplicity.

The record 600 can include an identifier 602 for one or more tags, and another identifier 604 for one or more tags. Here, the tags are labeled T1, T2, and T3, respectively, using the identifiers 602 and 604. In some implementations, the record 600 can reflect presence and/or proximity relating to respective pairs of tags corresponding to the identifiers 602 and 604. For example, a value 606 can reflect a determined confidence level that the tags T2 and T1 are within a particular proximity of each other. The value 606 can be determined by at least one of the tags T2 or T1, or by another device (e.g., a processing device). As another example, a value 608 can reflect a determined confidence level that the tags T1 and T3 are within a particular proximity of each other. The value 608 can be determined by at least one of the tags T1 or T3, or by another device (e.g., a processing device). As such, a memory of a tag (e.g., the memory 206 of the tag 200 in FIG. 2) can have stored therein a record (e.g., the record 600) reflecting confidence levels (e.g., the value 606 and/or 608) relating to respective ones of a plurality of tags (e.g., the tags T1, T2, and T3), the confidence levels based on the activity measure (e.g., determined by the activity component 304 in FIG. 3) for the corresponding one of the plurality of tags.

The records 400 (FIG. 4), 500 (FIG. 5), and/or 600 (FIG. 6) are examples of up-to-date records that relate to the presence, proximity, or movement of one or more tags. In some implementations, the record(s) can be created and kept by at least one entity in a system, and used for, or forwarded to another device for use in, developing and maintaining a contextual awareness of one or more circumstances relating to physical objects tracked by the system. For example, the processing device 108 (FIG. 1) can read such record(s) and take one or more corresponding actions. The entity can create the record based on information it receives from at least one tag or processing device, and/or based on inputs from one or more sensors of the entity.

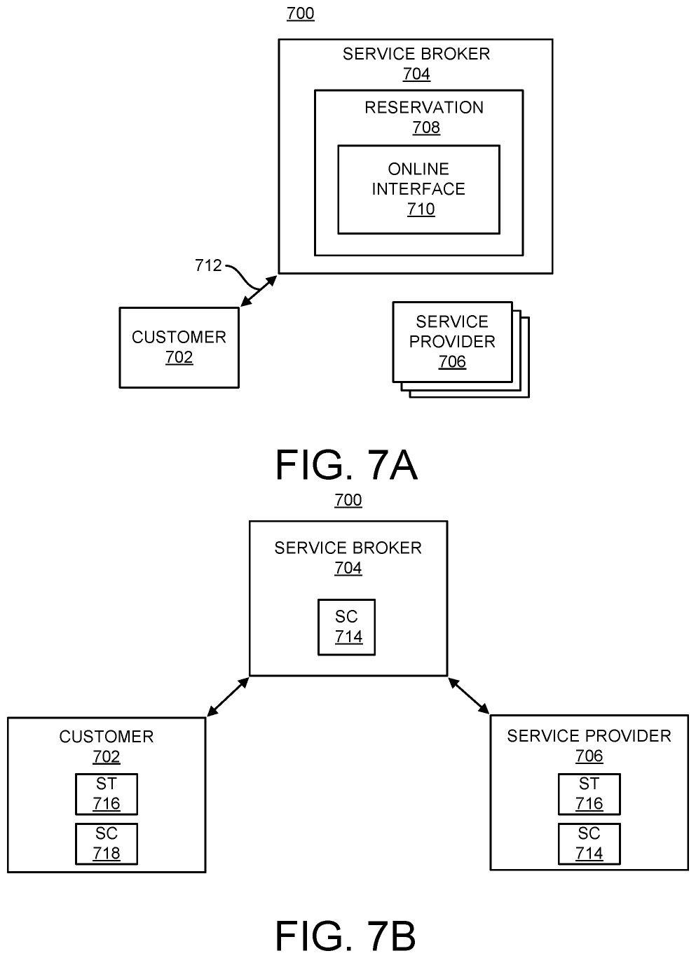

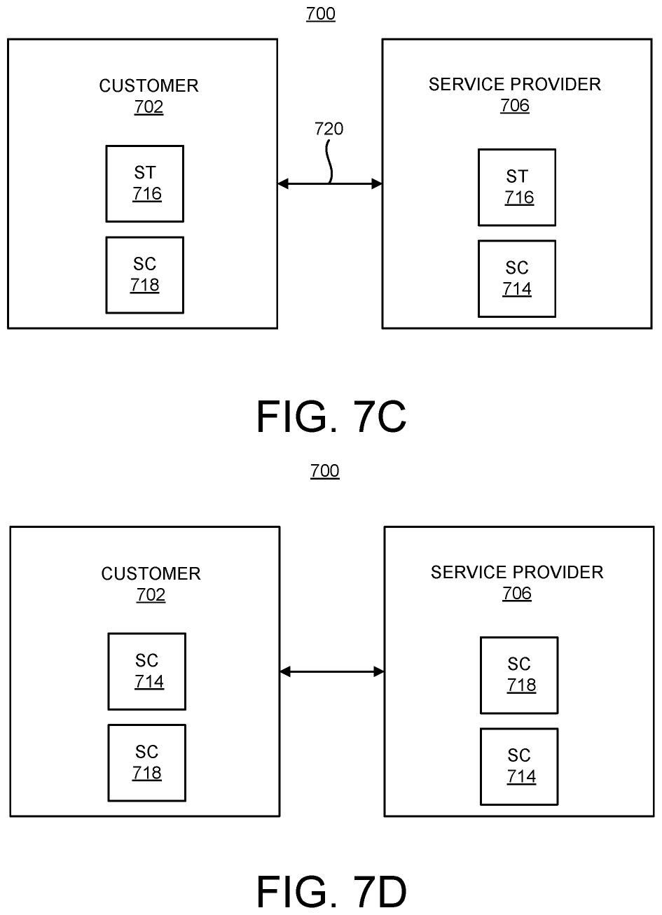

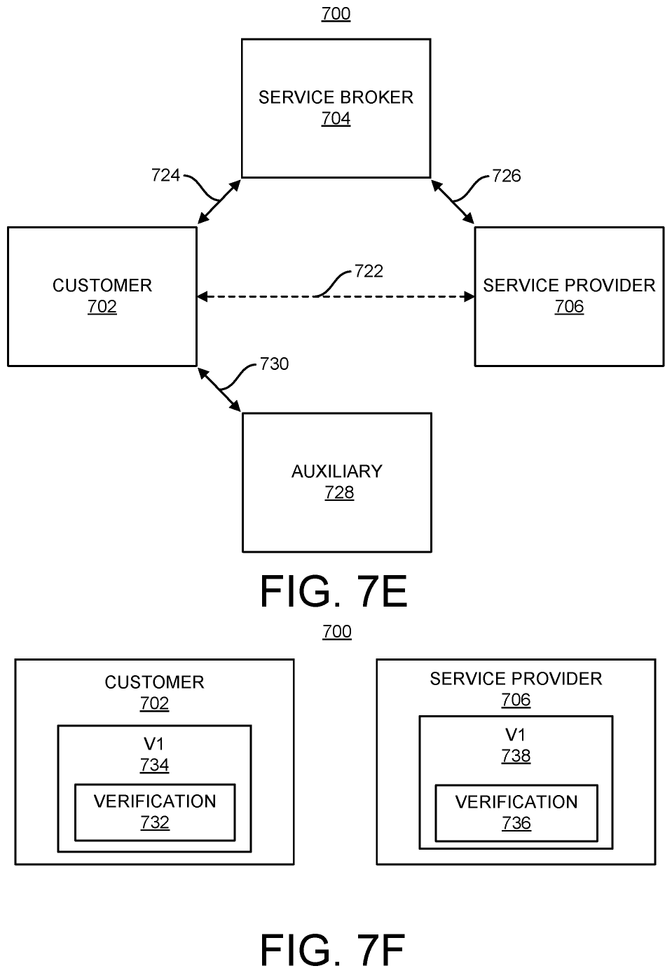

FIGS. 7A-F show examples relating to presence and identity verification. The examples are described with reference to a system 700 that can be used with one or more other examples described elsewhere herein. The system 700, or individual components thereof, can be implemented using one or more examples described herein with reference to FIG. 18.

The example in FIG. 7A shows the system 700 including a customer tag 702 that is configured for wireless communication. In some implementations, the customer tag 702 is configured to have its presence, proximity, and movement be managed by at least one other component (e.g., another tag, a parent tag, a hub, or another processing device). In some implementations, the customer tag 702 is configured to manage the presence, proximity, and movement of at least one other component (e.g., another tag, such as a child tag).

The customer tag 702 is associated with a customer. In some implementations, the customer is a prospective recipient of an O2O service. For example, the customer tag 702 can be used to verify presence and identity of at least one service provider regarding the O2O service.

The customer can approach a service broker regarding one or more O2O services. In the system 700, the service broker operates a service broker system 704. The service broker system 704 can be implemented using at least some examples described with reference to FIG. 18. In some implementations, the service broker uses the service broker system 704 to advertise one or more O2O services, accept reservations for O2O service(s), and to exchange booking information with one or more service provider tags 706.

Each of the service provider tags 706 is associated with one or more individuals who are prospective performers of at least one O2O service. The service provider tag 706 is configured for wireless communication. In some implementations, the service provider tag 706 is configured to have its presence, proximity, and movement be managed by at least one other component (e.g., another tag, a parent tag, a hub, or another processing device). In some implementations, the service provider tag 706 is configured to manage the presence, proximity, and movement of at least one other component (e.g., another tag, such as a child tag). The service provider tag 706 can be registered with the service broker system 704 in an onboarding process. For example, the onboarding process can be performed when a person is being enlisted to become registered as a service provider regarding one or more O2O services.

The service broker can provide a reservation process 708 that is available to the customer and others. In some implementations, the reservation process 708 is performed using the service broker system 704 and provides information and resources relating to at least one O2O service, including, but not limited to, service descriptions, service search functions, service provider location functions, booking tools, payment mechanisms, communication functions, or feedback submission tools. In some implementations, the reservation process 708 is performed using at least one software application program (e.g., an app) and/or an internet resource (e.g., one or more pages viewable in a browser). Here, the reservation process 708 includes an online interface 710 that is available to the customer. For example, the customer can exchange communications 712 with the reservation process 708 through the online interface 710 by way of the customer tag 702 or another processing device. That is, the customer is an example of a person associated with the customer tag 702 who can make a reservation for the O2O service(s) using the online interface 710 provided by the service broker of the service broker system 704.

FIG. 7B shows a state of the system 700 after the customer has initiated a reservation for the O2O service(s). The customer tag 702 may be associated with a pair of cryptography keys, such as a private key and a public key. The customer tag 702 can make at least one of the keys available to the service broker system 704 as part of engaging in the reservation process 708. In some implementations, the customer tag 702 provides the public key, or information equivalent to the public key, to the service broker system 704. For example, the service broker system 704 has here retrieved or otherwise received a security certificate 714 (labeled SC) from the customer tag 702, the security certificate 714 being an electronic document proving that the customer associated with the customer tag 702 is the owner of the public key. That is, the security certificate 714 is a security certificate for the customer tag 702.

One or more service providers can be selected for the O2O service(s) that the customer is reserving. In some implementations, the service broker system 704 performs the selection based on the communication 712 from the customer. In some implementations, the service broker presents two or more service providers (e.g., by way of respective identifiers) at the online interface 710 so that the customer can make a choice. Here, the service provider tag 706 is associated with the selected service provider and can engage in communications with at least the service broker system 704.

A session token 716 (labeled ST) is generated for the O2O service(s) that the customer is reserving. In some implementations, the service broker system 704 generates the session token 716. The session token 716 can be a secured, single-use, digitally signed token. For example, the session token 716 includes a set of information that is unique to the O2O service that the customer is reserving. The session token 716 can be provided to at least the customer tag 702. Here, the service broker system 704 provides the session token 716 also to the service provider tag 706. That is, the session token 716 can be common to the parties that are involved in the O2O service.

The service broker system 704 provides the security certificate 714 of the customer tag 702 to the service provider tag 706. The service provider tag 706 can receive the session token 716 and the security certificate 714 in the same communication or in multiple communications.

The service provider tag 706 may be associated with a pair of cryptography keys, such as a private key and a public key. The service provider tag 706 can make at least one of the keys available to the service broker system 704 as part of an onboarding process. In some implementations, the service provider tag 706 provides the public key, or information equivalent to the public key, to the service broker system 704. For example, the service broker system 704 has previously retrieved or otherwise received a security certificate 718 from the service provider tag 706 and has provided the security certificate 718 to the customer tag 702 as part of the reservation process 708. The security certificate 718 is an electronic document proving that the person (i.e., the service provider) associated with the service provider tag 706 is the owner of the public key. That is, the security certificate 718 is a security certificate for the service provider tag 706.

The O2O service may be scheduled for performance at a specific time, within a certain time interval, or at an essentially arbitrary time (e.g., as soon as possible). Performance of the O2O service may be done in an offline context. In some implementations, the O2O service may include a rideshare arrangement where the service provider associated with the service provider tag 706 is to use a vehicle to transport the customer associated with the customer tag 702. In some implementations, the O2O service includes an arrangement where the service provider associated with the service provider tag 706 is to enter premises of the customer. For example, the service provider is a builder, contractor, plumber, electrician, computer technician, mechanic, domestic help, fitness consultant, health care provider, entertainer, or the like, and the customer is a person whose house or other dwelling or property is implicated by the O2O service.

At one or more points in time, the customer and the service provider may physically be near each other. A verification of presence and identity can then be performed. For example, the identity component 315 (FIG. 3) can be used. FIG. 7C shows the customer tag 702 and the service provider tag 706 separated by a distance 720. The spatial proximity may occur due to the nature of the O2O service being performed, or it may be a preliminary stage before the service provider begins performing the O2O service, to name just two examples. The physical closeness can be reflected in a corresponding spatial proximity of the customer tag 702 and the service provider tag 706, as here indicated by the distance 720. For example, each of the customer tag 702 and the service provider tag 706 is a wireless device communicating using one or more wireless protocols. The range of wireless communications from either the customer tag 702 or the service provider tag 706 may depend on multiple factors, including, but not limited to, the type of wireless equipment (e.g., kind(s) of transmitter, receiver, or transceiver used), operational status, power supply, interference, obstructions, weather, atmospheric conditions, and the like.

The distance 720 can represent a situation where the customer tag 702 and the service provider tag 706 are within range of each other, to name just one example. Each of the customer tag 702 and the service provider tag 706 can transmit a corresponding beacon that can be observed by any wireless receivers that are within range of the tag. The term beacon is here being used to refer to the wireless (e.g., radio) signal that is being transmitted. The beacon can include one or more unique identifiers that may be associated with the tag that transmits the beacon. The beaconing of either the customer tag 702 or the service provider tag 706, or both, can be performed continuously, at regular intervals, or randomly, over a shorter or longer period of time, to name just a few examples.

When the customer tag 702 and the service provider tag 706 are within range, they can receive each other's beacon(s). In some implementations, the beacon of at least one of the tags includes unencrypted (e.g., plaintext) information. The beacon may include the session token 716. For example, including the session token 716 in the beacon may be advantageous in that it can help the other tag(s) involved in the O2O service identify the beacon for purposes of connecting with the originating tag. In some implementations, the beacon of at least one of the tags includes encrypted information. For example, either of the customer tag 702 or the service provider tag 706, or both, may encrypt the beacon using the public key of the other tag. This facilitates that the other tag can decrypt the beacon using its corresponding key. By identifying the correct other tag using the session token 716 in the corresponding received beacon, each of the customer tag 702 and the service provider tag 706 can establish connection with the other.

The customer tag 702 and the service provider tag 706 can exchange one or more keys with each other for purposes of establishing secure connection. FIG. 7D shows an example of exchanging certificates. The described exchanges may occur simultaneously, or in any respective order. The customer tag 702 has provided the security certificate 718 (e.g., the public key of the service provider tag 706) to the service provider tag 706. Accordingly, the service provider tag 706 currently has access to (at least) the security certificate 718 of the customer tag 702, and its own security certificate (e.g., the private key of the service provider tag 706). For example, the service provider tag 706 can establish an encryption key using at least this information, and use the encryption key for secure communication with the customer tag 702. That is, the service provider tag 706 can use the described exchange(s) to verify that the customer tag 702 is the tag of the customer who reserved the O2O service in the reservation process 708, which O2O service is uniquely associated with the session token 716.

The service provider tag 706 has provided the security certificate 714 (e.g., the public key of the customer tag 702) to the customer tag 702. Accordingly, the customer tag 702 currently has access to (at least) the security certificate 714 of the service provider tag 706, and its own security certificate (e.g., the private key of the customer tag 702). For example, the customer tag 702 can establish an encryption key using at least this information, and use the encryption key for secure communication with the service provider tag 706. That is, the customer tag 702 can use the described exchange(s) to verify that the service provider tag 706 is the tag of the service provider that was selected to perform the O2O service in the reservation process 708, which O2O is uniquely associated with the session token 716.

The above examples illustrate that receiving the security certificate of the other tag, and the session token 716, can include: the customer tag 702 receiving an encrypted communication from the service provider tag 706, or vice versa; the customer tag 702 decrypting the encrypted communication using the security certificate of the service provider tag 706, or vice versa; and the customer tag 702 or the service provider tag 706 determining that the encrypted communication includes the session token 716.

FIG. 7E shows an example that either of the customer tag 702 or the service provider tag 706, or both, can determine a distance 722 between the customer tag 702 and the service provider tag 706. In some implementations, a proximity criterion can be established by the customer tag 702, the service provider tag 706, the service broker system 704, or another entity. The proximity criterion can define a greatest separation between the customer tag 702 and the service provider tag 706 at which either or both of the customer tag 702 and the service provider tag 706 can verify the presence and identity of the other device. In a rideshare scenario, for example, the vehicle with which the service provider tag 706 is associated may be one of multiple (potentially similar) vehicles that are currently near the customer tag 702. Accordingly, while the wireless range of the customer tag 702 and the service provider tag 706 may permit verification at a distance greater than the proximity criterion, the proximity criterion can be imposed for additional certainty in the verification. In some implementations, the proximity criterion is satisfied when the customer tag 702 and the service provider tag 706 are within range of each other.

The customer tag 702 can engage in one or more communications 724 with the service broker system 704 regarding its verification. For example, the communication 724 can provide the session token 716 and inform the service broker system 704 that the customer tag 702 has verified the presence and identity of the service provider tag 706 for the O2O service. The service broker system 704 can, by way of the communication 724, provide an acknowledgement to the customer tag 702 that the session token 716 is the identifier for the O2O service that the customer booked using the reservation process 708. For example, this can provide the customer carrying the customer tag 702 an additional level of confidence that the service broker system 704—the entity with which the customer interacted in reserving the O2O service—also acknowledges that the customer has identified the correct service provider (i.e., the custodian of the service provider tag 706) for performing the O2O service.

The service provider tag 706 can engage in one or more communications 726 with the service broker system 704 regarding its verification. For example, the communication 726 can provide the session token 716 and inform the service broker system 704 that the service provider tag 706 has verified the presence and identity of the customer tag 702 for the O2O service. The service broker system 704 can, by way of the communication 726, provide an acknowledgement to the service provider tag 706 that the session token 716 is the identifier of the O2O service which the service provider was selected to perform. For example, this can provide the service provider carrying the service provider tag 706 an additional level of confidence that the service broker system 704—the entity by whom the service provider was appointed for performing the O2O service—also acknowledges that the service provider has identified the correct customer (i.e., the custodian of the customer tag 702) in relation to the O2O service.

Either the customer tag 702 or the service provider tag 706, or both, can perform a multi-factor verification of the other. In some implementations, an auxiliary component 728 is also associated with the O2O service. The auxiliary component 728 may be a piece of equipment for performing the O2O service. For example, in a rideshare scenario the auxiliary component 728 can be the vehicle to be used by the service provider. When the service provider tag 706 is onboarded to the service broker system 704, an identifier for the auxiliary component 728 can be provided to the service broker system 704. When the customer makes the reservation for the O2O service, the service broker system 704 can provide the identifier for the auxiliary component 728 to the customer tag 702. The auxiliary component 728 can be a tag equivalent to the customer tag 702 or the service provider tag 706, or both, or the auxiliary component 728 can be another wireless component or device (e.g., an NFC component of a vehicle or other equipment). One or more communications 730 between the auxiliary component 728 and, in this example, the customer tag 702, can be performed similarly to the above-described exchange of certificates between the customer tag 702 and the service provider tag 706. As another example, the communications 730 can involve the customer tag 702 detecting a standard identifier that the auxiliary component 728 beacons in the ordinary course of its operation. Accordingly, the detection by the customer tag 702 of an identifier from the auxiliary component 728, by the one or more communications 730, can provide the customer additional verification that the service provider is the correct one, and that the correct equipment is present.

One or more of the customer tag 702 and the service provider tag 706 can provide a communication to the other. For example, the customer tag 702 can confirm to the service provider tag 706 that the customer tag 702 has identified the presence and identity of the service provider tag 706. As another example, the service provider tag 706 can confirm to the customer tag 702 that the service provider tag 706 has identified the presence and identity of the customer tag 702. Either or both of such confirmations can serve as a confirmation of the O2O service.

One or more of the customer tag 702 and the service provider tag 706 can provide an output regarding the verification(s) of presence and identity of the other. FIG. 7F shows an example where a verification 732 is output using a user interface 734 (labeled UI) of the customer tag 702. For example, this can provide the customer who is the custodian of the customer tag 702 an assurance that the customer tag 702 has identified the presence and identity of the service provider tag 706. As another example, a verification 736 is output using a user interface 738 of the service provider tag 706. For example, this can provide the service provider who is the custodian of the service provider tag 706 an assurance that the service provider tag 706 has identified the presence and identity of the customer tag 702.

The above examples illustrate that a method can include receiving, in the customer tag 702 and from the service broker system 704, the security certificate 718 for the service provider tag 706 and the session token 716 corresponding to the O2O service. The method can include determining, by the customer tag 702, that the service provider tag 706 satisfies a proximity criterion (e.g., the distance 722) with regard to the customer tag 702; receiving, in the customer tag 702 and from the service provider tag 706, the security certificate 718 and the session token 716; and generating, by the customer tag 702 and in response to the determination and the receipt of the security certificate 718 and the session token 716, the verification 736 that verifies the custodian of the service provider tag 706 as provider of the O2O service.

Performing presence and identity verification by way of the customer tag 702 and the service provider tag 706 can provide one or more advantages. In some implementations, the customer tag 702 and the service provider tag 706 seamlessly perform the presence and identity verification without prompting or input by the corresponding custodian. As such, the custodian may not need to manipulate any device to perform the verification; rather, when the proximity is sufficient and the security certificate and session token check out, the user may simply notice that the corresponding customer tag 702 or the service provider tag 706 outputs a verification to confirm the presence and identity.

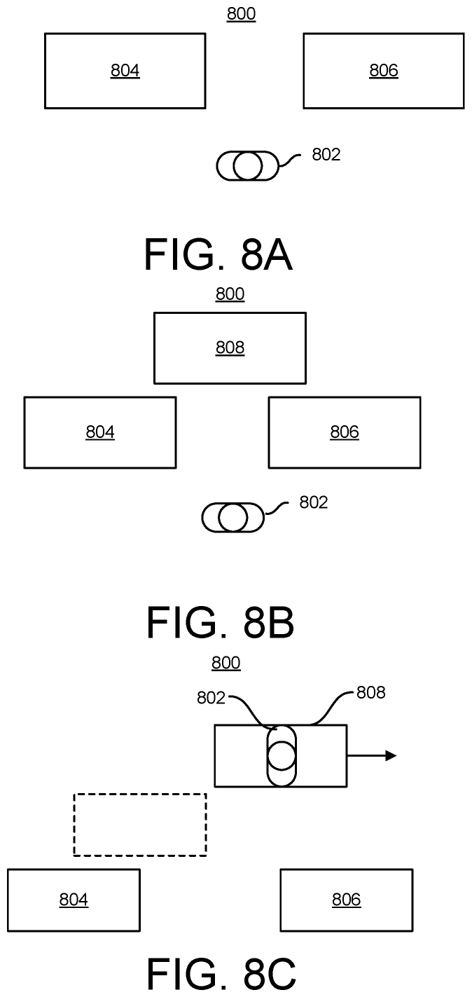

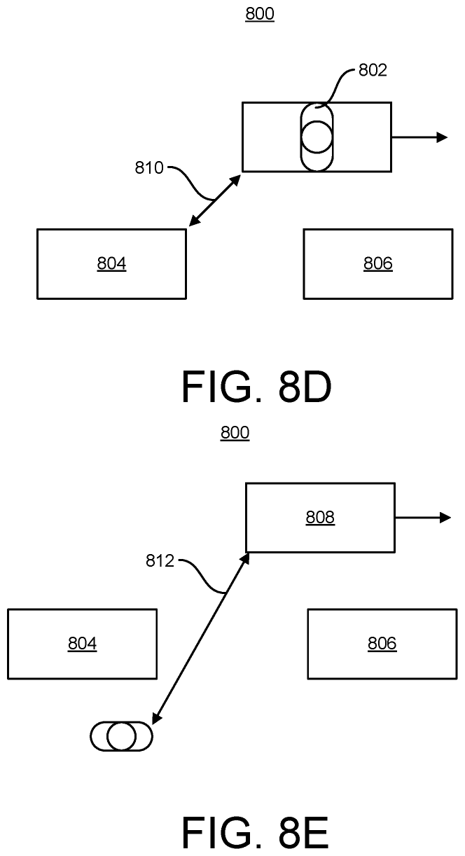

FIGS. 8A-E show examples relating to a rideshare arrangement at a location 800. The examples can be used with one or more other examples described elsewhere herein. Individual components described with regard to the examples can be implemented using one or more examples described herein with reference to FIG. 18.

The location 800 is schematically shown in a top view and can be a place where rideshare drivers and passengers meet. The location 800 can be adjacent to a curb, a sidewalk, an airport, a station, a place of employment, a residence, a sports venue, or a hospital, to name just a few examples. Currently present at the location 800 as shown in FIG. 8A are a customer 802 and vehicles 804 and 806 that may be parked or stopped. The customer 802 has made a reservation for an O2O service, namely that a rideshare driver will pick up the customer 802 at the location 800 for travel to another location. The customer 802 is carrying a tag, which can be any of the tags described elsewhere herein. For example, the customer 802 is carrying the customer tag 702 (FIGS. 7A-F).

FIG. 8B shows that a vehicle 808 has arrived at the location 800. The customer 802 may believe that the vehicle 808 is the one for the rideshare that the customer 802 has booked. The driver of that vehicle, moreover, is also carrying a corresponding tag, which can be any of the tags described elsewhere herein. For example, the rideshare driver is carrying the service provider tag 706 (FIGS. 7A-F).

As the tag of the customer 802 and the tag of the rideshare driver come into each other's range, they can seek to find one another, such as because they are beaconing signals that include the unique session token for the O2O service. For example, a successful exchange between them can involve exchange of a session token and respective security certificates, so as to establish a secure connection. Based on a successful secure exchange, and a determination that a proximity criterion is met, the customer tag may provide a verification to the customer 802 that the rideshare driver has been identified. The customer 802 can then enter the vehicle of the rideshare driver and begin the travel in accordance with the O2O service. Here, FIG. 8C shows that the customer 802 has entered the vehicle 808 which is currently traveling away from the location 800. The tag of the customer 802 senses that the distance to the tag of the rideshare driver remains essentially unchanged as the travel begins, which is another indication of a correctly performed presence and identity verification. That is, the present example illustrates that the customer 802 successfully verifies the presence and identity of the rideshare driver, and then enters the correct vehicle based on that verification.

Assume instead that despite the verification by the tag, the customer 802 inadvertently entered the wrong vehicle. FIG. 8D shows a situation where the vehicle 804 was the correct rideshare vehicle, not the vehicle 808. Upon detecting that a distance 810 between the tag of the customer 802 and the vehicle 804 increases, and optionally other context, the tag can generate an alert to the customer 802 to inform about the mistake. That is, the present example illustrates that the tag of the customer 802, after generating the verification output, can determine that the tag of the vehicle 804 no longer satisfies the proximity criterion with regard to the tag of the customer 802 and that the O2O service is not yet complete. In response, the tag of the customer 802 can generate the alert as another output.

Assume instead, as shown in FIG. 8E, that the vehicle 808 was the correct vehicle for the customer 802, but for some reason, the customer 802 does not enter before the vehicle 808 begins to leave the location 800. For example, the rideshare arrangement may have involved multiple passengers being picked up at the location 800 (e.g., in a so-called “pool” or “shared” arrangement), and the driver of the vehicle 808 may mistakenly begin to leave the location 800 before the customer 802 has entered. Upon detecting that a distance 812 between the tag of the customer 802 and the vehicle 808 increases, and optionally other context, the tag can generate an alert to the customer 802 to inform about the mistake. That is, the present example illustrates that the tag of the customer 802, after generating the verification output, can determine that the tag of the vehicle 808 no longer satisfies the proximity criterion with regard to the tag of the customer 802 and that the O2O service is not yet complete. In response, the tag of the customer 802 can generate the alert as another output.

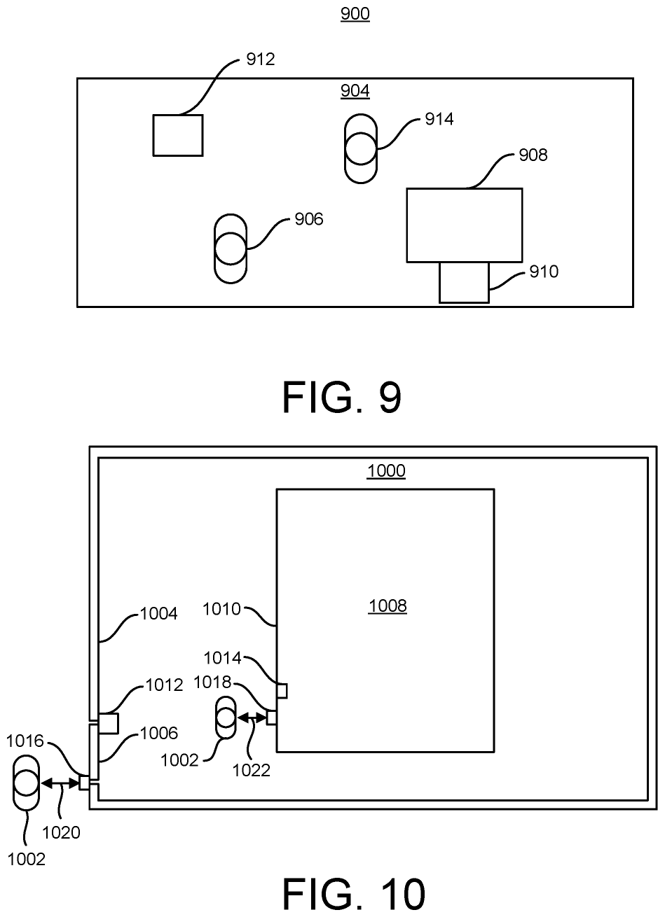

FIG. 9 shows another example relating to a rideshare arrangement. The examples are described with reference to a system 900 that is here schematically shown from above and the system 900 can be used with one or more other examples described elsewhere herein. The system 900, or individual components thereof, can be implemented using one or more examples described herein with reference to FIG. 18.

The system 900 involves a customer 902 and includes a vehicle 904. The customer 902 carries a tag (e.g., the customer tag 702 in FIGS. 7A-F) which can be considered part of the system 900. Assume that the customer 902 has booked a rideshare via a service broker, and that the vehicle 904 has approached the customer 902. The vehicle 904 is being driven by a driver 906. The vehicle 904 can be used as part of a multifactor verification of the driver 906 regarding the O2O service.

The vehicle 904 can beacon one or more signals. In some implementations, the vehicle 904 has a native system 908 (e.g., a vehicle computer system) that contains information about the vehicle including, but not limited to, a vehicle identification number (VIN), the make and/or model of the vehicle 904, status information of the vehicle 904, such as it is in operating condition or whether any sensor warnings for the vehicle 904 have been generated, and the like. Such or other information may be accessible through a port or other connection of the native system 908, in some cases an on-board diagnostics (OBD) port. For example, a tag 910 (e.g., any of the tags exemplified elsewhere herein) can be coupled to the native system 908 to retrieve one or more pieces of information. The tag 910 can beacon a vehicle token containing one or more of the pieces of information from the native system 908. For example, the VIN can be beaconed.

In some implementations, the vehicle 904 has an auxiliary tag 912. For example, the auxiliary tag 912 comprises, or is included in, a system provided by a service broker as part of onboarding the driver 906 to the rideshare arrangement. The auxiliary tag 912 can be positioned in any of multiple locations on the vehicle 904, such as on a windshield. The auxiliary tag 912 can beacon information unique to the vehicle 904, or other information, or both. In some implementations, the auxiliary tag 912 beacons the VIN and/or a session token for the O2O service. For example, the vehicle token can be specific to the O2O session (e.g., by including the session token) and may have been provided to the vehicle by the service broker.

The above example illustrates that using the vehicle 904 as part of a multifactor authentication can include: the tag of the customer 902 receiving, in reservation with the reservation for the O2O service being made, a vehicle token from the service broker; the tag of the customer 902 receiving, in association with the security-certificate verification of the driver 906, a vehicle token from the vehicle 904 by way of the tag 910 or the auxiliary tag 912; and the tag of the customer 902 determining a correspondence between the vehicle tokens. Accordingly, by receiving beaconed information from the tag 910 and/or the auxiliary tag 912, the tag of the customer 902 can perform additional verification of the presence and identity of the driver 906. For example, the customer 902 can verify that the driver 906 is operating the vehicle 904 that is recognized by the service broker.

In some implementations, the vehicle 904 can be used to transport two or more rideshare passengers simultaneously. For example, this may occur when the O2O service includes in a so-called “pool” or “shared” arrangement involving multiple passengers. Such passenger(s) may enter the vehicle 904 before, at the same time as, or after the customer 902 enters the vehicle 904. In this example, a passenger 914 is present in the vehicle 904 around the time when the tag of the customer 902 is engaging in secure communication with the tag of the driver 906. The tag of the customer 902 can also engage in communications with a tag of the passenger 914. In some implementations, when another passenger becomes associated with the multi-passenger rideshare arrangement, that passenger's public key can be provided by the service broker to the other passenger(s). That is, the tag of the customer 902 may have received the public key of the passenger 914 when making the reservation, or at a later time. Upon sensing a beacon of the tag of the passenger 914 in the vehicle 904, the tag of the customer 902 can engage in essentially the same type of handshaking that has been exemplified above (e.g., with reference to FIGS. 7A-F). If the information checks out, then the tag of the customer 902 can issue a verification confirmation that encompasses at least the presence and identity of the driver 906 and the presence and identity of the passenger 914 (optionally, also the presence and identity of the vehicle 904). The above example illustrates that verifying the passenger 914 can include: the tag of the customer 902 receiving, from the service broker, a passenger token; the tag of the customer 902 receiving, in association with verification of the driver 906, a passenger token from the tag of the passenger 914; and the tag of the customer 902 determining a correspondence between the passenger tokens.

FIG. 10 shows an example relating to presence and identity verification regarding premises 1000. The premises 1000 are here schematically shown from above and individual components of these examples can be used with one or more other examples described elsewhere herein. Individual components of these examples can be implemented using one or more examples described herein with reference to FIG. 18

Assume that a person, here called the proprietor, owns or controls the premises 1000, which may include a piece of real estate, a house, an apartment, a storage facility, a parking spot, or the like. The proprietor may approach a service broker and arrange for O2O services that relate to the premises 1000. For example, the proprietor books a dog walker for the proprietor's dog (not shown), which is housed at the premises 1000. Accordingly, according to the arrangement with the service broker, another person, here shown as service provider 1002, should enter the premises 1000 as part of performing the O2O services.

The premises 1000 includes a wall 1004 surrounding the premises 1000, with a gate 1006 to selectively open the wall 1004. The premises 1000 includes a building 1008 (e.g., a house, factory, barn, or a shed), with a door 1010 to selectively open the building 1008. A gate lock 1012 includes electronic equipment that controls (e.g., locks and unlocks) the gate 1006, and a door lock 1014 includes electronic equipment that controls (e.g., locks and unlocks) the door 1010. A tag 1016 is coupled to the gate lock 1012 (e.g., by way of wired or wireless communication). For example, the tag 1016 can instruct the gate lock 1012 to lock or unlock the gate 1006. A tag 1018 is coupled to the door lock 1014 (e.g., by way of wired or wireless communication). For example, the tag 1018 can instruct the door lock 1014 to lock or unlock the door 1010.

The service provider 1002 is associated with a tag (e.g., any of the tags described elsewhere herein). The tag has one or more security certificates. When the proprietor makes a reservation for the O2O services, the service broker may provide the proprietor with one or more security certificates of the service provider 1002 that is selected for the O2O services. For example, the security certificate can be provided to a wireless device (e.g., another tag) that the proprietor uses to make the reservation, and the proprietor can thereafter provide the security certificate to the tag 1016 and/or the tag 1018. As another example, the service broker can provide the security certificate to the tag 1016 and/or the tag 1018 as part of the reservation process. A session token unique to the O2O service can also be provided to the tag of the service provider 1002 and to the tag 1016 and/or the tag 1018.

When the tag of the service provider 1002 comes within range of the tag 1016, it can be determined whether the security certificates match each other (e.g., as described in other examples herein) and whether a distance 1020 between the service provider 1002 and the tag 1016, and/or a distance 1022 between the service provider 1002 and the tag 1018, satisfy a proximity criterion. If anything fails to correspond, access to the premises 1000 and/or the building 1008 can be denied. For example, this can involve the tag 1016 and/or the tag 1018 taking action to lock the gate 1006 or the door 1010, respectively, or abstaining from unlocking the gate 1006 or the door 1010, respectively, when already locked. By contrast, if the security certificates are found to be in order, the session token matches that given by the service broker, and the proximity criterion is met, the gate 1006 or the door 1010, or both, can be unlocked

The above examples illustrate that a method can include receiving, in the tag 1016 or the tag 1018 and from the service broker, the security certificate for the tag of the service provider 1002 and the session token corresponding to the O2O service to be performed at the premises 1000. The method can include determining, by the tag 1016 or the tag 1018, that the tag of the service provider 1002 satisfies a proximity criterion (e.g., the distance 1020 or the distance 1022) with regard to the tag 1016 or the tag 1018; receiving, in the tag 1016 or the tag 1018 and from the tag of the service provider 1002, the security certificate and the session token; and generating, by the tag 1016 or the tag 1018 and in response to the determination and the receipt of the security certificate and the session token, a verification (e.g., unlocking the gate lock 1012 and/or unlocking the door lock 104) that verifies the service provider 1002, as custodian of the tag, as the provider of the O2O service.

Performing presence and identity verification by way of the tag 1016 or the tag 1018 can provide one or more advantages. In some implementations, the tag 1016 or the tag 1018 seamlessly performs the presence and identity verification without prompting or input by the service provider 1002 or the proprietor. As such, the service provider 1002 or the proprietor may not need to manipulate any device to perform the verification; rather, when the proximity is sufficient and the security certificate and session token check out, the service provider 1002 or the proprietor may simply notice that the corresponding customer tag 702 or the service provider tag 706 causes the gate lock 1012 and/or the door lock 104 to be unlocked, to confirm the presence and identity.

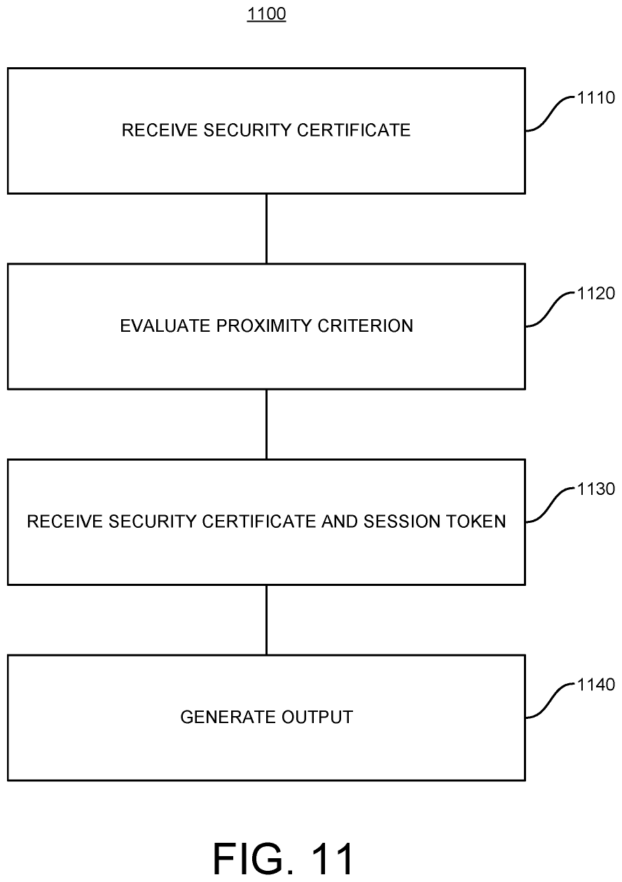

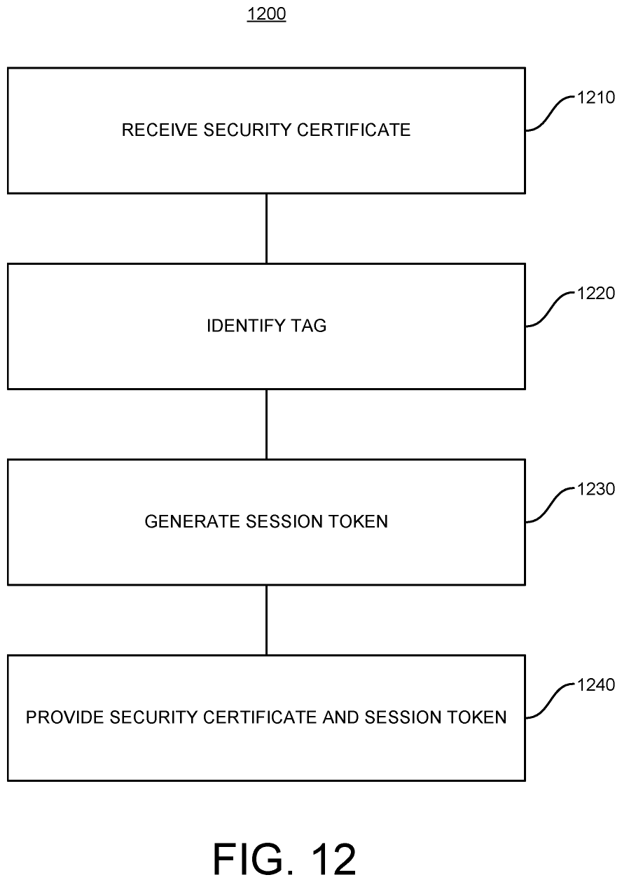

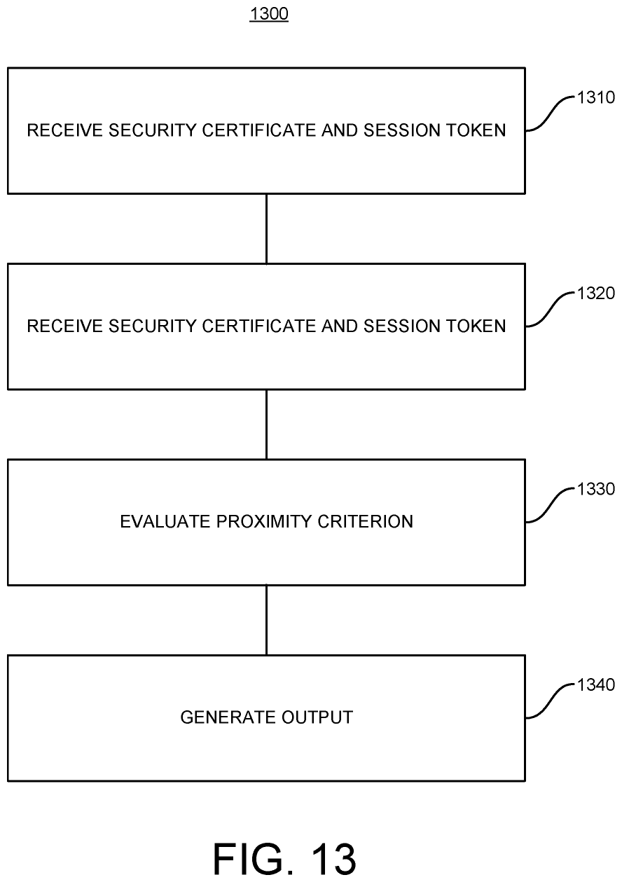

FIGS. 11-13 show examples of methods 1100, 1200, and 1300, relating to presence and identity verification. The methods 1100, 1200, and/or 1300 can be used with one or more other examples described elsewhere herein. The method 1100, 1200, and/or 1300 can be performed using one or more examples described with reference to FIG. 18. More or fewer operations than shown can be performed. Two or more operations can be performed in another order unless otherwise indicated.

At 1110, a security certificate and a session token corresponding to an arrangement can be received. The security certificate can be received in a first tag. The first security certificate can relate to a second tag. For example, the customer tag 702 (FIGS. 7A-F) receives the security certificate 718 of the service provider tag 706, and the session token 716. In some implementations, the arrangement corresponds to an O2O service. In some implementations, the security certificate is received from an arrangement broker system, such as a service broker system.

At 1120, it can be determined, by the first tag, that the second tag satisfies a proximity criterion with regard to the first tag. For example, upon the customer tag 702 (FIGS. 7A-F) and the service provider tag 706 coming into range of each other, it can be determined that the distance 722 does not exceed a limit.

At 1130, there can be received, in the first tag and from the second tag, the first security certificate and the session token. For example, in FIGS. 7C-D the customer tag 702 receives the security certificate 714 and the session token 716.

At 1140, there can be generated, by the first tag and in response to the determination and the receipt of the first security certificate and the session token, a first output corresponding to verification of a custodian of the second tag as a participant in the arrangement. For example, in FIG. 7F the customer tag 702 generates the verification 732 in response to the determination regarding the proximity criterion and the receipt of the security certificate 714 and the session token 716.

Turning now to the method 1200, at 1210 there can be received, in an arrangement broker system and from a first tag, a first security certificate for the first tag, the first security certificate received in association with an arrangement involving a first person. The first tag can be associated with the first person. In some implementations, the arrangement broker system can include a service broker system. For example, the service broker system 704 (FIGS. 7A-F) can receive the security certificate 714 from the customer tag 702 in association with the customer making a reservation for an O2O service using the reservation process 708. In some implementations, the arrangement involves an O2O service for which a reservation is made.

At 1220, there can be identified, by the arrangement broker system, a second tag associated with a second person also involved in the arrangement. In some implementations, the second person is to perform an O2O service of the arrangement. For example, the service broker system 704 can identify the service provider tag 706 as being associated with the selected service provider.

At 1230, there can be generated, by the arrangement broker system, a session token for the arrangement. For example, the service broker system 704 can generate the session token 716.

At 1240, there can be provided, by the arrangement broker system and to the second tag, the first security certificate and the session token. For example, the service broker system 704 can provide the session token 716 and the security certificate 714 to the service provider tag 706.

Turning now to the method 1300, at 1310 there can be received, by a tag, a security certificate and a session token. In some implementations, the session token relates to an arrangement, including, but not limited to, an O2O service. For example, the service provider tag 706 (FIGS. 7A-F) can receive the session token 716 and the security certificate 714 from the service broker system 704 in FIG. 7B.

At 1320, there can be received, by a tag, a security certificate and a session token. For example, the service provider tag 706 (FIGS. 7A-F) can receive the session token 716 and the security certificate 714 from the customer tag 702 in FIGS. 7C-D.

At 1330, there can be evaluated, by the tag, a proximity criterion. For example, the service provider tag 706 evaluates the distance 722.

At 1340, an output can be generated. For example, the service provider tag 706 can output a verification of presence or identity, or an alert, depending on the output of the determinations.

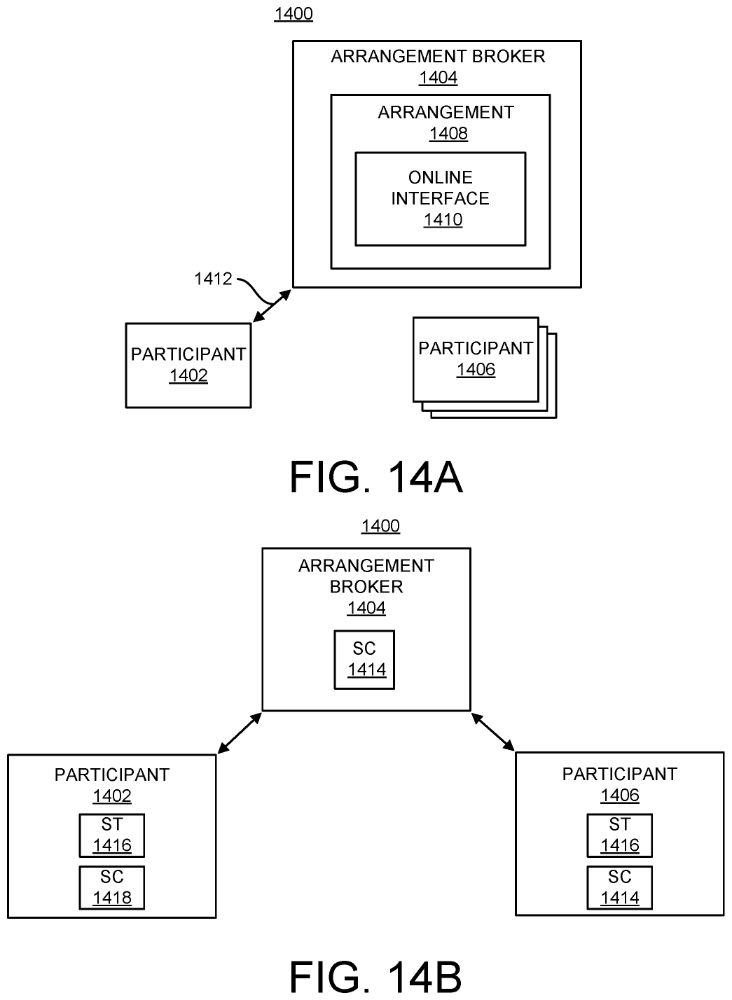

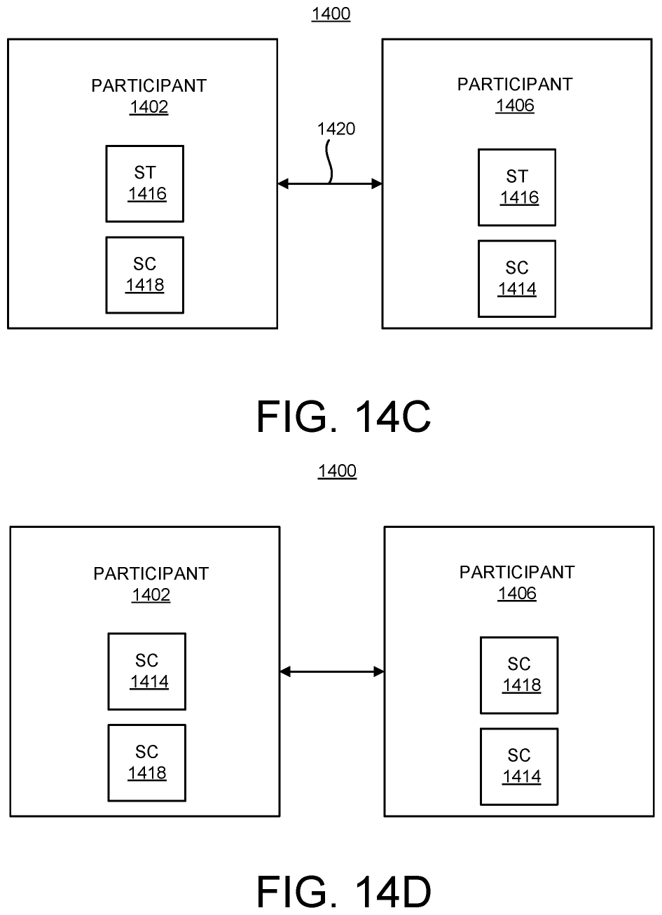

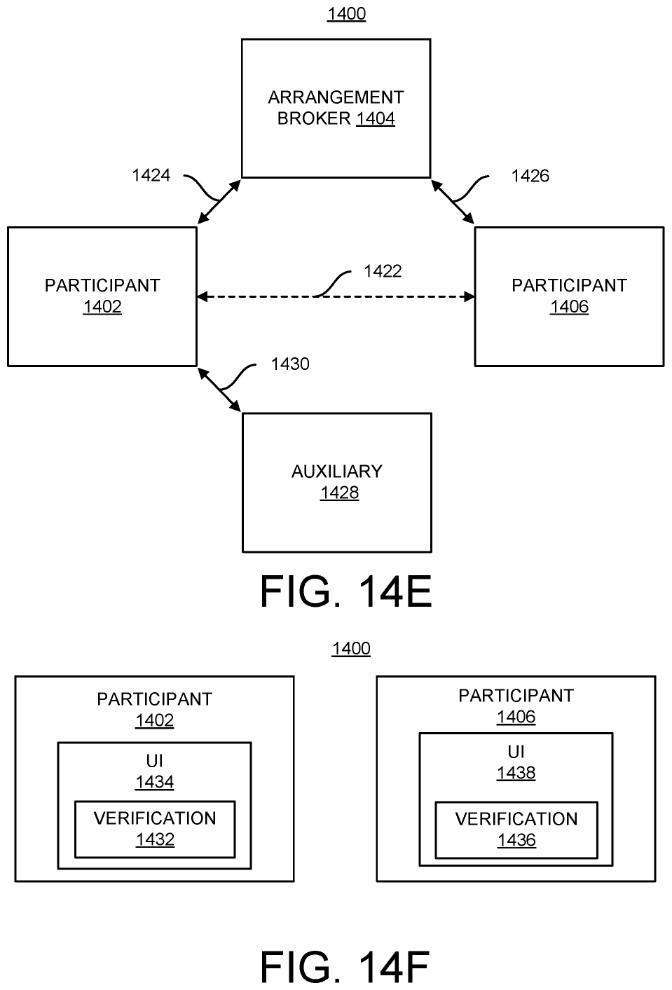

FIGS. 14A-F show examples relating to presence and identity verification. The examples are described with reference to a system 1400 that can be used with one or more other examples described elsewhere herein. The system 1400, or individual components thereof, can be implemented using one or more examples described herein with reference to FIG. 18.

The example in FIG. 14A shows the system 1400 including a participant tag 1402 that is configured for wireless communication. In some implementations, the participant tag 1402 is configured to have its presence, proximity, and movement be managed by at least one other component (e.g., another tag, a parent tag, a hub, or another processing device). In some implementations, the participant tag 1402 is configured to manage the presence, proximity, and movement of at least one other component (e.g., another tag, such as a child tag).

The participant tag 1402 is associated with a participant in an O2O arrangement. In some implementations, the participant is to participate in an encounter according to, or following, the O2O arrangement. For example, the arrangement can involve a meeting between two or more people who were connected with each other using an online tool (e.g., a dating app or matchmaking service). As another example, the participant is a prospective recipient of an O2O service. For example, the participant tag 1402 and/or the participant tag 1406 can be used to verify presence and identity of at least one service provider regarding the O2O service. The participant tag 1402 can be used to verify presence and identity of at least one other participant relating to the O2O arrangement.

The participant can approach an arrangement broker regarding one or more O2O arrangements. In the system 1400, the arrangement broker operates an arrangement broker system 1404. The arrangement broker system 1404 can be implemented using at least some examples described with reference to FIG. 18. In some implementations, the arrangement broker uses the arrangement broker system 1404 to advertise the possibility of engaging in one or more O2O arrangements and to exchange arrangement information with one or more other participant tags 1406.

Each of the participant tags 1406 is associated with one or more individuals who are prospective participants in at least one O2O arrangement. The participant tag 1406 is configured for wireless communication. In some implementations, the participant tag 1406 is configured to have its presence, proximity, and movement be managed by at least one other component (e.g., another tag, a parent tag, a hub, or another processing device). In some implementations, the participant tag 1406 is configured to manage the presence, proximity, and movement of at least one other component (e.g., another tag, such as a child tag). The participant tags 1402 and 1406 can be registered with the arrangement broker system 1404 in respective onboarding processes. For example, the onboarding process can be performed when a person is being enlisted to become registered as a potential participant regarding one or more O2O arrangements.

The arrangement broker can provide an arrangement process 1408 that is available to the participant(s) and others. The arrangement process 1408 can be performed using the arrangement broker system 1404 and provide information and resources relating to at least one O2O arrangement. In some implementations, the arrangement includes, but is not limited to, profile creation tools (e.g., to enter information about the participant and/or about someone the participant seeks to encounter with), a search function (e.g., to pair the participant's profile with the profile of one or more other participants), and communication tools (e.g., to facilitate communication between two or more participants who have been paired with each other using the arrangement process 1408). In some implementations, the arrangement process 1408 is performed using at least one software application program (e.g., an app) and/or an internet resource (e.g., one or more pages viewable in a browser). Here, the arrangement process 1408 includes an online interface 1410 that is available to the participants. For example, the participant can exchange communications 1412 with the arrangement process 1408 through the online interface 1410 by way of the participant tag 1402 or another processing device. That is, the participant is an example of a person associated with the participant tag 1402 who can make an O2O arrangement using the online interface 1410 provided by the arrangement broker of the arrangement broker system 1404.

FIG. 14B shows a state of the system 1400 after the participant has initiated an O2O arrangement. The participant tag 1402 may be associated with a pair of cryptography keys, such as a private key and a public key. The participant tag 1402 can make at least one of the keys available to the arrangement broker system 1404 as part of engaging in the arrangement process 1408. In some implementations, the participant tag 1402 provides the public key, or information equivalent to the public key, to the arrangement broker system 1404. For example, the arrangement broker system 1404 has here retrieved or otherwise received a security certificate 1414 (labeled SC) from the participant tag 1402, the security certificate 1414 being an electronic document proving that the participant associated with the participant tag 1402 is the owner of the public key. That is, the security certificate 1414 is a security certificate for the participant tag 1402.

One or more other participants can be selected for the O2O arrangement(s) in which the participant is to engage. In some implementations, the arrangement broker system 1404 performs the selection based on the communication 1412 from the participant. In some implementations, the arrangement broker presents two or more participants (e.g., by way of respective identifiers) to the participant at the online interface 1410 so that the participant can make a choice. In some implementations, the arrangement broker presents each of two or more participants the corresponding prospective participants (e.g., by way of respective identifiers) at the online interface 1410 so that each of them can make input affecting the selection (e.g., only if all participants agree will the pairing be manifested). Here, the participant tag 1406 is associated with the selected participant and can engage in communications with at least the arrangement broker system 1404.

A session token 1416 (labeled ST) is generated for the O2O arrangement(s) of the participant. In some implementations, the arrangement broker system 1404 generates the session token 1416. The session token 1416 can be a secured, single-use, digitally signed token. For example, the session token 1416 includes a set of information that is unique to the O2O arrangement of the participant. The session token 1416 can be provided to at least the participant tag 1402. Here, the arrangement broker system 1404 provides the session token 1416 also to the participant tag 1406. That is, the session token 1416 can be common to the parties that are participants in the O2O arrangement.

The arrangement broker system 1404 provides the security certificate 1414 of the participant tag 1402 to the participant tag 1406, and/or vice versa. The participant tag 1406 can receive the session token 1416 and the security certificate 1414 in the same communication or in multiple communications.

The participant tag 1406 may be associated with a pair of cryptography keys, such as a private key and a public key. The participant tag 1406 can make at least one of the keys available to the arrangement broker system 1404 as part of an onboarding process. In some implementations, the participant tag 1406 provides the public key, or information equivalent to the public key, to the arrangement broker system 1404. For example, the arrangement broker system 1404 has previously retrieved or otherwise received a security certificate 1418 from the participant tag 1406 and has provided the security certificate 1418 to the participant tag 1402 as part of the arrangement process 1408. The security certificate 1418 is an electronic document proving that the person (i.e., the participant) associated with the participant tag 1406 is the owner of the public key. That is, the security certificate 1418 is a security certificate for the participant tag 1406.

The O2O arrangement may be scheduled for performance at a specific time, or within a certain time interval, or at an essentially arbitrary time (e.g., as soon as possible), or not be scheduled by the arrangement broker. The O2O arrangement (e.g., a meeting or other encounter between persons) may be done in an offline context. In some implementations, the O2O arrangement may include a personal encounter where the participant associated with the participant tag 1406 and the participant associated with the participant tag 1402 are to meet with each other.

At one or more points in time, the participants associated with the respective participant tags 1402 and 1406 may physically be near each other. For example, this can occur at a location proposed by the arrangement broker system 1404, or a mutually agreed location. A verification of presence and identity can then be performed. For example, the identity component 315 (FIG. 3) can be used. FIG. 14C shows the participant tag 1402 and the participant tag 1406 separated by a distance 1420. The spatial proximity may occur due to the nature of the O2O arrangement, or it may be a preliminary stage before the encounter between the participants, to name just two examples. The physical closeness can be reflected in a corresponding spatial proximity of the participant tag 1402 and the participant tag 1406, as here indicated by the distance 1420. For example, each of the participant tag 1402 and the participant tag 1406 is a wireless device communicating using one or more wireless protocols. The range of wireless communications from either the participant tag 1402 or the participant tag 1406 may depend on multiple factors, including, but not limited to, the type of wireless equipment (e.g., kind(s) of transmitter, receiver, or transceiver used), operational status, power supply, interference, obstructions, weather, atmospheric conditions, and the like.

The distance 1420 can represent a situation where the participant tag 1402 and the participant tag 1406 are within range of each other, to name just one example. Each of the participant tag 1402 and the participant tag 1406 can transmit a corresponding beacon that can be observed by any wireless receivers that are within range of the tag. The term beacon is here being used to refer to the wireless (e.g., radio) signal that is being transmitted. The beacon can include one or more unique identifiers that may be associated with the tag that transmits the beacon. The beaconing of either the participant tag 1402 or the participant tag 1406, or both, can be performed continuously, at regular intervals, or randomly, over a shorter or longer period of time, to name just a few examples.

When the participant tag 1402 and the participant tag 1406 are within range, they can receive each other's beacon(s). In some implementations, the beacon of at least one of the tags includes unencrypted (e.g., plaintext) information. The beacon may include the session token 1416. For example, including the session token 1416 in the beacon may be advantageous in that it can help the other tag(s) involved in the O2O arrangement identify the beacon for purposes of connecting with the originating tag. In some implementations, the beacon of at least one of the tags includes encrypted information. For example, either of the participant tag 1402 or the participant tag 1406, or both, may encrypt the beacon using the public key of the other tag. This facilitates that the other tag can decrypt the beacon using its corresponding key. By identifying the correct other tag using the session token 1416 in the corresponding received beacon, each of the participant tag 1402 and the participant tag 1406 can establish connection with the other.

The participant tag 1402 and the participant tag 1406 can exchange one or more keys with each other for purposes of establishing secure connection. FIG. 14D shows an example of exchanging certificates. The described exchanges may occur simultaneously, or in any respective order. The participant tag 1402 has provided the security certificate 1418 (e.g., the public key of the participant tag 1406) to the participant tag 1406. Accordingly, the participant tag 1406 currently has access to (at least) the security certificate 1418 of the participant tag 1402, and its own security certificate (e.g., the private key of the participant tag 1406). For example, the participant tag 1406 can establish an encryption key using at least this information, and use the encryption key for secure communication with the participant tag 1402. That is, the participant tag 1406 can use the described exchange(s) to verify that the participant tag 1402 is the tag of the participant who made the O2O arrangement in the arrangement process 1408, which O2O arrangement is uniquely associated with the session token 1416.

The participant tag 1406 has provided the security certificate 1414 (e.g., the public key of the participant tag 1402) to the participant tag 1402. Accordingly, the participant tag 1402 currently has access to (at least) the security certificate 1414 of the participant tag 1406, and its own security certificate (e.g., the private key of the participant tag 1402). For example, the participant tag 1402 can establish an encryption key using at least this information, and use the encryption key for secure communication with the participant tag 1406. That is, the participant tag 1402 can use the described exchange(s) to verify that the participant tag 1406 is the tag of the participant that was selected to engage in the O2O arrangement in the arrangement process 1408, which O2O arrangement is uniquely associated with the session token 1416.

The above examples illustrate that receiving the security certificate of the other tag, and the session token 1416, can include: the participant tag 1402 receiving an encrypted communication from the participant tag 1406, or vice versa; the participant tag 1402 decrypting the encrypted communication using the security certificate of the participant tag 1406, or vice versa; and the participant tag 1402 or the participant tag 1406 determining that the encrypted communication includes the session token 1416.

FIG. 14E shows an example that either of the participant tag 1402 or the participant tag 1406, or both, can determine a distance 1422 between the participant tag 1402 and the participant tag 1406. In some implementations, a proximity criterion can be established by the participant tag 1402, the participant tag 1406, the arrangement broker system 1404, or another entity. The proximity criterion can define a greatest separation between the participant tag 1402 and the participant tag 1406 at which either or both of the participant tag 1402 and the participant tag 1406 can verify the presence and identity of the other device. In a personal meeting between participants in a public or semi-public location, for example, a participant with which the participant tag 1406 is associated may be one of multiple people that are currently near the participant tag 1402. Accordingly, while the wireless range of the participant tag 1402 and the participant tag 1406 may permit verification at a distance greater than the proximity criterion, the proximity criterion can be imposed for additional certainty in the verification. In some implementations, the proximity criterion is satisfied when the participant tag 1402 and the participant tag 1406 are within range of each other.

The participant tag 1402 can engage in one or more communications 1424 with the arrangement broker system 1404 regarding its verification. For example, the communication 1424 can provide the session token 1416 and inform the arrangement broker system 1404 that the participant tag 1402 has verified the presence and identity of the participant tag 1406 for the O2O arrangement. The arrangement broker system 1404 can, by way of the communication 1424, provide an acknowledgement to the participant tag 1402 that the session token 1416 is the identifier for the O2O arrangement of the participant. For example, this can provide the participant carrying the participant tag 1402 an additional level of confidence that the arrangement broker system 1404—the entity with which the participant interacted regarding the O2O arrangement—also acknowledges that the participant has identified the correct participant (i.e., the custodian of the participant tag 1406) for the O2O arrangement.

The participant tag 1406 can engage in one or more communications 1426 with the arrangement broker system 1404 regarding its verification. For example, the communication 1426 can provide the session token 1416 and inform the arrangement broker system 1404 that the participant tag 1406 has verified the presence and identity of the participant tag 1402 for the O2O arrangement. The arrangement broker system 1404 can, by way of the communication 1426, provide an acknowledgement to the participant tag 1406 that the session token 1416 is the identifier of the O2O arrangement with which the participant is associated. For example, this can provide the participant carrying the participant tag 1406 an additional level of confidence that the arrangement broker system 1404—the entity with which the participant interacted regarding the O2O arrangement—also acknowledges that the participant has identified the correct participant (i.e., the custodian of the participant tag 1402) for the O2O arrangement.

Either the participant tag 1402 or the participant tag 1406, or both, can perform a multi-factor verification of the other. In some implementations, an auxiliary component 1428 is also associated with the O2O arrangement. The auxiliary component 1428 may be a piece of equipment involved in, or otherwise associated with, the O2O arrangement. When the participant tag 1402 and/or 1406 is onboarded to the arrangement broker system 1404, an identifier for the auxiliary component 1428 can be provided to the arrangement broker system 1404. When the participant interacts regarding the O2O arrangement, the arrangement broker system 1404 can provide the identifier for the auxiliary component 1428 to the other tag, such as the participant tag 1402. The auxiliary component 1428 can be a tag equivalent to the participant tag 1402 or the participant tag 1406, or both, or the auxiliary component 1428 can be another wireless component or device (e.g., an NFC component of a vehicle or other equipment). One or more communications 1430 between the auxiliary component 1428 and, in this example, the participant tag 1402, can be performed similarly to the above-described exchange of certificates between the participant tag 1402 and the participant tag 1406. As another example, the communications 1430 can involve the participant tag 1402 detecting a standard identifier that the auxiliary component 1428 beacons in the ordinary course of its operation. Accordingly, the detection by the participant tag 1402 of an identifier from the auxiliary component 1428, by the one or more communications 1430, can provide the participant additional verification that the other participant is the correct one, and that the correct equipment is present.

One or more of the participant tag 1402 and the participant tag 1406 can provide a communication to the other. For example, the participant tag 1402 can confirm to the participant tag 1406 that the participant tag 1402 has identified the presence and identity of the participant tag 1406. As another example, the participant tag 1406 can confirm to the participant tag 1402 that the participant tag 1406 has identified the presence and identity of the participant tag 1402. Either or both of such confirmations can serve as a confirmation of the O2O arrangement.

One or more of the participant tag 1402 and the participant tag 1406 can provide an output regarding the verification(s) of presence and identity of the other. FIG. 14F shows an example where a verification 1432 is output using a user interface 1434 (labeled UI) of the participant tag 1402. For example, this can provide the participant who is the custodian of the participant tag 1402 an assurance that the participant tag 1402 has identified the presence and identity of the participant tag 1406. As another example, a verification 1436 is output using a user interface 1438 of the participant tag 1406. For example, this can provide the participant who is the custodian of the participant tag 1406 an assurance that the participant tag 1406 has identified the presence and identity of the participant tag 1402.

The above examples illustrate that a method can include receiving, in the participant tag 1402 and from the arrangement broker system 1404, the security certificate 1418 for the participant tag 1406 and the session token 1416 corresponding to the O2O arrangement. The method can include determining, by the participant tag 1402, that the participant tag 1406 satisfies a proximity criterion (e.g., the distance 1422) with regard to the participant tag 1402; receiving, in the participant tag 1402 and from the participant tag 1406, the security certificate 1418 and the session token 1416; and generating, by the participant tag 1402 and in response to the determination and the receipt of the security certificate 1418 and the session token 1416, the verification 1436 that verifies the custodian of the participant tag 1406 as participant in the O2O arrangement.

Performing presence and identity verification by way of the participant tag 1402 and the participant tag 1406 can provide one or more advantages. In some implementations, the participant tag 1402 and the participant tag 1406 seamlessly perform the presence and identity verification without prompting or input by the corresponding custodian. As such, the custodian may not need to manipulate any device to perform the verification; rather, when the proximity is sufficient and the security certificate and session token check out, the user may simply notice that the corresponding participant tag 1402 or the participant tag 1406 outputs a verification to confirm the presence and identity.

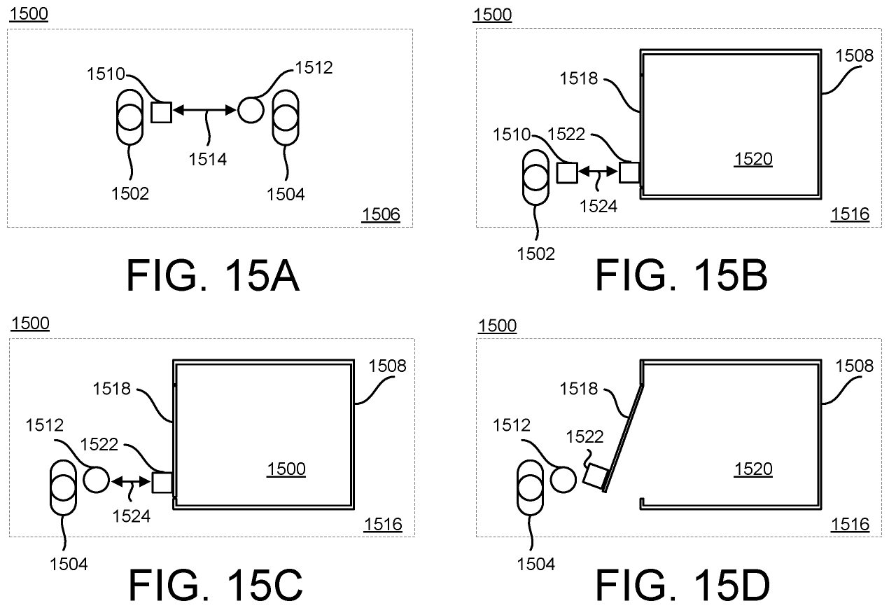

FIGS. 15A-D show other examples relating to presence and identity verification regarding premises. The examples are described with reference to a system 1500 that can be used with one or more other examples described elsewhere herein. The system 1500, or individual components thereof, can be implemented using one or more examples described herein with reference to FIG. 18.

FIG. 15A shows that a person 1502 and a person 1504 are present in a context 1506. In some implementations, the context 1506 corresponds to an environment where online access is not available to the persons 1502 and 1504. For example, the context 1506 can be an isolated location, or a place that for another reason is not conducive to wireless communication from remote locations.

The persons 1502 and 1504 can engage in a pre-authorization process for an arrangement between them. In some implementations, the person 1502 is in possession of premises 1508 (FIG. 15B) and wishes to grant the person 1504 at least a temporary permission to enter the premises 1508. The premises 1508 may be located within or outside (e.g., near or far away from) the context 1506 where the pre-authorization process takes place. The pre-authorization process seeks to ensure that the person 1504 will subsequently be able to enter the premises 1508, in accordance with the permission granted as part of the arrangement between them, although the permission is being granted while neither party has online access in the context 1506 (and at a time when neither of the persons 1502 and 1504 is near the premises 1508).

The person 1502 has a device 1510. The device 1510 can be any electronic device mentioned or described herein, including, but not limited to, a tag, a smartphone, a handheld wireless device, a wearable device, a tablet, a laptop, or a personal computer. The person 1504 has a tag 1512. The tag 1512 can be, or include, or be included within, any of the tags described elsewhere herein.

The device 1510 may be associated with a pair of cryptography keys, such as a private key and a public key. The device 1510 can make at least one of the keys available to the tag 1512 as part of the pre-authorization process. In some implementations, the device 1510 provides the public key, or information equivalent to the public key, to the tag 1512. For example, the tag 1512 can retrieve or otherwise receive, by way of one or more communications 1514, a security certificate from the device 1510, the security certificate being an electronic document proving that the person 1502 associated with the device 1510 is the owner of the public key. That is, the security certificate is a security certificate for the device 1510.

A session token is generated for the arrangement. In some implementations, the device 1510 generates the session token. The session token can be a secured, single-use, digitally signed token. For example, the session token includes a set of information that is unique to the arrangement between the persons 1502 and 1504 (i.e., the arrangement to grant the person 1504 at least temporary access to the premises 1508). The session token can be provided to at least the tag 1512. Here, the device 1510 provides the session token to the tag 1512 by the communications 1514. The session token can be common to the parties that are involved in the arrangement.

The tag 1512 may be associated with a pair of cryptography keys, such as a private key and a public key. The tag 1512 can make at least one of the keys available to the device 1510 as part of the pre-authorization process. In some implementations, the tag 1512 provides the public key, or information equivalent to the public key, to the device 1510. For example, the device 1510 can retrieve or otherwise receive, by way of the one or more communications 1514, a security certificate from the tag 1512, the security certificate being an electronic document proving that the person 1504 associated with the tag 1512 is the owner of the public key. That is, the security certificate is a security certificate for the tag 1512.

Turning now to FIG. 15B, the person 1502 is present in a context 1516 that includes the premises 1508. The depicted situation can occur subsequent to the pre-authorization process described above with reference to FIG. 15A. In some implementations, the context 1516 can provide at least some form of online access to the person 1502. As another example, the context 1516 may not provide online access.

The premises 1508 includes a building (e.g., a house, factory, barn, or a shed), with a door 1518 to selectively open the building to get access to an interior 1520. A lock 1522 includes electronic equipment that controls (e.g., locks and unlocks) the door 1518. In some implementations, a tag is coupled to the lock 1522 (e.g., by way of wired or wireless communication). For example, the tag can instruct the lock 1522 to lock or unlock the door 1518.

Here, at least one communication 1524 takes place between the device 1510 and the lock 1522 (e.g., with the tag coupled to the lock 1522). The communication(s) 1522 can provide information to the lock 1522 about the arrangement between the person 1502 and the person 1504 (FIG. 15A). In some implementations, the device 1510 provides the public key of the tag 1512 (FIG. 15A), or information equivalent to that public key, to the lock 1522. For example, the device 1510 can provide the security certificate for the tag 1512 to the lock 1522. In some implementations, the device 1510 provides the session token to the lock 1522. For example, the session token can inform the lock 1522 about any time restriction(s) regarding the arrangement between the persons 1502 and 1504. The communication(s) 1524 can be direct or indirect. For example, the device 1510 provides the information by one or more of: Bluetooth communication, BLE communication, Zigbee communication, Wi-Fi communication, LTE communication, NFC, LoRa communication, UWB communication, RFID communication, Ethernet, Ethernet over powerline, or NB.

Turning now to FIG. 15C, at a later time the person 1504 is present in the context 1516 to gain access to the premises 1508 according to the arrangement. The person 1504 currently has the tag 1512. At one or more points in time, the person 1504 and the lock 1522 may physically be near each other. A verification of presence and identity can then be performed. For example, the identity component 315 (FIG. 3) can be used. The physical closeness can be reflected in a corresponding spatial proximity of the tag 1512 and the lock 1522. For example, each of the tag 1512 and the lock 1522 has a wireless device communicating using one or more wireless protocols. The range of wireless communications from either the tag 1512 or the lock 1522 may depend on multiple factors, including, but not limited to, the type of wireless equipment (e.g., kind(s) of transmitter, receiver, or transceiver used), operational status, power supply, interference, obstructions, weather, atmospheric conditions, and the like.

When the tag 1512 and the lock 1522 are within range, they can receive each other's beacon(s). In some implementations, the beacon of at least one of the tags includes unencrypted (e.g., plaintext) information. The beacon may include the session token. For example, including the session token in the beacon may be advantageous in that it can help the other tag(s) involved in the arrangement identify the beacon for purposes of connecting with the originating tag. In some implementations, the beacon of at least one of the tags includes encrypted information. For example, either of the tag 1512 or the lock 1522, or both, may encrypt the beacon using the public key of the other tag. This facilitates that the other tag can decrypt the beacon using its corresponding key. By identifying the correct other tag using the session token in the corresponding received beacon, each of the tag 1512 and the lock 1522 can establish connection with the other.

The tag 1512 and the lock 1522 can exchange one or more keys with each other for purposes of establishing secure connection. The described exchanges may occur simultaneously, or in any respective order. The tag 1512 can provide the security certificate (e.g., the public key of the lock 1522) to the lock 1522. Accordingly, the lock 1522 currently has access to (at least) the security certificate of the tag 1512, and its own security certificate (e.g., the private key of the lock 1522). For example, the lock 1522 can establish an encryption key using at least this information, and use the encryption key for secure communication with the tag 1512. That is, the lock 1522 can use the described exchange(s) to verify that the tag 1512 is the tag of the participant of the arrangement.

Upon verification by at least the lock 1522 of the presence and identity of the tag 1512, the lock 1522 can unlock itself, or be unlocked. FIG. 15D shows an example where the door 1518 has been opened and the person 1504 has access to the interior 1520 of the premises 1508. The lock 1522 can monitor the duration of the access by the person 1504 (e.g., in accordance with the arrangement) and can take action (e.g., generate a reminder and/or a third-party alert) if necessary.

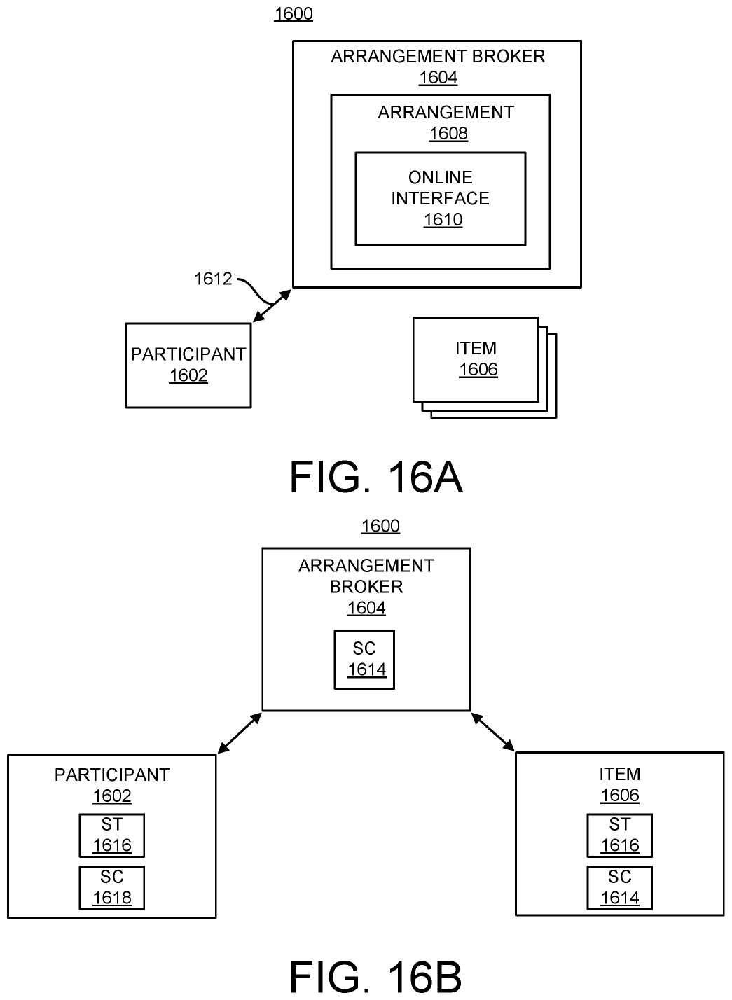

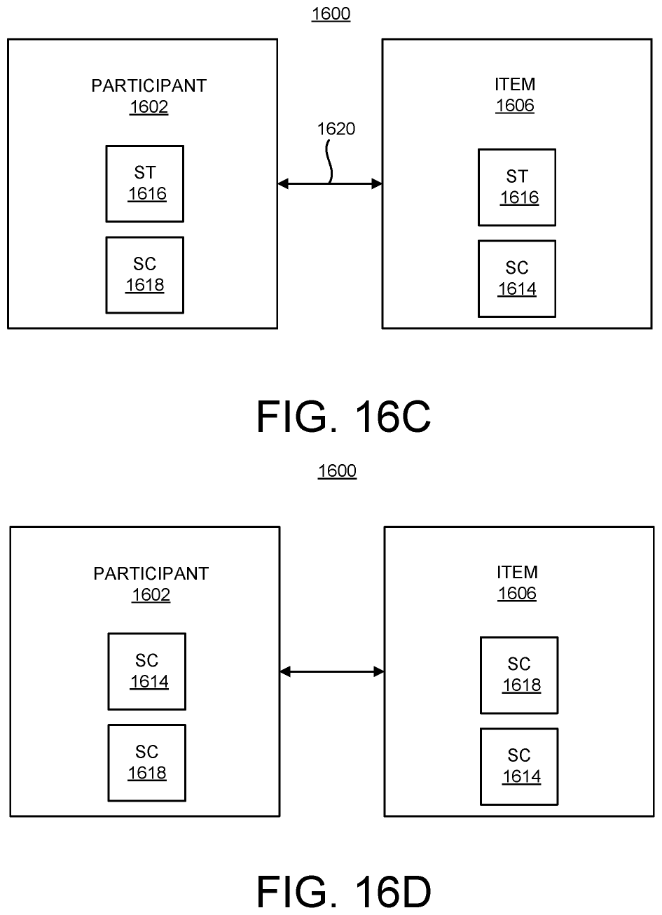

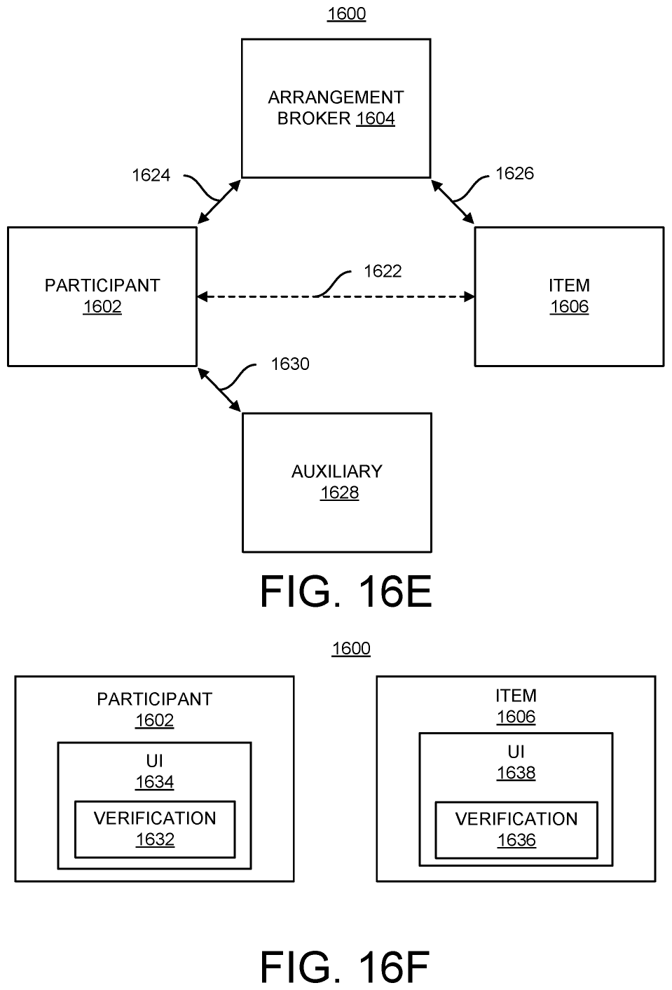

FIGS. 16A-F show examples relating to presence and identity verification. The examples are described with reference to a system 1600 that can be used with one or more other examples described elsewhere herein. The system 1600, or individual components thereof, can be implemented using one or more examples described herein with reference to FIG. 18.

The example in FIG. 16A shows the system 1600 including a participant tag 1602 that is configured for wireless communication. In some implementations, the participant tag 1602 is configured to have its presence, proximity, and movement be managed by at least one other component (e.g., another tag, a parent tag, a hub, or another processing device). In some implementations, the participant tag 1602 is configured to manage the presence, proximity, and movement of at least one other component (e.g., another tag, such as a child tag).

The participant tag 1602 is associated with a participant in an arrangement. In some implementations, the arrangement involves the participant using an item (e.g., a physical object or other thing). For example, the arrangement can involve the participant being permitted to use the item(s) for a predefined time. For example, the participant tag 1602 and/or an item tag 1606 can be used to verify presence and identity of at least one participant regarding the arrangement.

The participant can approach an arrangement broker regarding one or more arrangements. In the system 1600, the arrangement broker operates an arrangement broker system 1604. The arrangement broker system 1604 can be implemented using at least some examples described with reference to FIG. 18. In some implementations, the arrangement broker uses the arrangement broker system 1604 to advertise the possibility of engaging in one or more arrangements to use the item(s) and to exchange arrangement information with one or more item tags 1606.

Each of the item tags 1606 is associated with one or more items that are available for use according to an arrangement. The item tag 1606 is configured for wireless communication. In some implementations, the item tag 1606 is configured to have its presence, proximity, and movement be managed by at least one other component (e.g., another tag, a parent tag, a hub, or another processing device). In some implementations, the item tag 1606 is configured to manage the presence, proximity, and movement of at least one other component (e.g., another tag, such as a child tag). The participant tag 1602 and the item tag 1606 can be registered with the arrangement broker system 1604 in respective onboarding processes. For example, an owner of the item can register the item with the arrangement broker system 1604 for use in one or more arrangements. As another example, the person associated with the participant tag 1602 can register the participant tag 1602 with the arrangement broker system 1604 for participating in one or more arrangements regarding items.

The arrangement broker can provide an arrangement process 1608 that is available to the participant(s) and others. The arrangement process 1608 can be performed using the arrangement broker system 1604 and provide information and resources relating to at least one arrangement. In some implementations, the arrangement includes, but is not limited to, profile creation tools (e.g., to enter information about the participant and/or about the item(s) the participant seeks to have access to), a search function (e.g., to pair the participant's profile with the item(s)), and communication tools (e.g., to facilitate communication between two or more participants regarding an item). In some implementations, the arrangement process 1608 is performed using at least one software application program (e.g., an app) and/or an internet resource (e.g., one or more pages viewable in a browser). Here, the arrangement process 1608 includes an online interface 1610 that is available to the participant(s). For example, the participant can exchange communications 1612 with the arrangement process 1608 through the online interface 1610 by way of the participant tag 1602 or another processing device. That is, the participant is an example of a person associated with the participant tag 1602 who can make an arrangement using the online interface 1610 provided by the arrangement broker of the arrangement broker system 1604.

FIG. 16B shows a state of the system 1600 after the participant has initiated an arrangement. The participant tag 1602 may be associated with a pair of cryptography keys, such as a private key and a public key. The participant tag 1602 can make at least one of the keys available to the arrangement broker system 1604 as part of engaging in the arrangement process 1608. In some implementations, the participant tag 1602 provides the public key, or information equivalent to the public key, to the arrangement broker system 1604. For example, the arrangement broker system 1604 has here retrieved or otherwise received a security certificate 1614 (labeled SC) from the participant tag 1602, the security certificate 1614 being an electronic document proving that the participant associated with the participant tag 1602 is the owner of the public key, and provided the security certificate 1614 to the item tag 1606. That is, the security certificate 1614 is a security certificate for the participant tag 1602.

One or more items can be selected for the arrangement(s) in which the participant is to engage. In some implementations, the arrangement broker system 1604 performs the selection based on the communication 1612 from the participant. In some implementations, the arrangement broker presents two or more items (e.g., by way of respective identifiers) to the participant at the online interface 1610 so that the participant can make a choice. In some implementations, the arrangement broker presents each of two or more participants the prospective items (e.g., by way of respective identifiers) at the online interface 1610 so that each of them can make input affecting the selection (e.g., only if all participants agree will the arrangement be manifested). Here, the item tag 1606 is associated with the selected item and can engage in communications with at least the arrangement broker system 1604.

A session token 1616 (labeled ST) is generated for the arrangement(s) of the participant. In some implementations, the arrangement broker system 1604 generates the session token 1616. The session token 1616 can be a secured, single-use, digitally signed token. For example, the session token 1616 includes a set of information that is unique to the arrangement of the participant. The session token 1616 can be provided to at least the participant tag 1602. Here, the arrangement broker system 1604 provides the session token 1616 also to the item tag 1606. That is, the session token 1616 can be common to the parties or entities that are participants in the O2O arrangement.

The arrangement broker system 1604 provides the security certificate 1614 of the participant tag 1602 to the item tag 1606, and/or vice versa. The item tag 1606 can receive the session token 1616 and the security certificate 1614 in the same communication or in multiple communications.

The item tag 1606 may be associated with a pair of cryptography keys, such as a private key and a public key. The item tag 1606 can make at least one of the keys available to the arrangement broker system 1604 as part of an onboarding process. In some implementations, the item tag 1606 provides the public key, or information equivalent to the public key, to the arrangement broker system 1604. For example, the arrangement broker system 1604 has previously retrieved or otherwise received a security certificate 1618 from the item tag 1606 and has provided the security certificate 1618 to the participant tag 1602 as part of the arrangement process 1608. The security certificate 1618 is an electronic document proving that the person associated with the item tag 1606 (e.g., the owner of the item) is the owner of the public key. That is, the security certificate 1618 is a security certificate for the item tag 1606.

The arrangement may be scheduled for performance at a specific time, or within a certain time interval, or at an essentially arbitrary time (e.g., as soon as possible), or not be scheduled by the arrangement broker. The arrangement (e.g., access to the item(s) by one or more persons) may be done in an offline context.

At one or more points in time, the participant associated with the participant tag 1602 may be physically near the item tag 1606. For example, this can occur at a location proposed by the arrangement broker system 1604, or a default location for the item. A verification of presence and identity can then be performed. For example, the identity component 315 (FIG. 3) can be used. FIG. 16C shows the participant tag 1602 and the item tag 1606 separated by a distance 1620. The spatial proximity may occur due to the nature of the arrangement, or it may be a preliminary stage before the encounter between the participant and the item, to name just two examples. The physical closeness can be reflected in a corresponding spatial proximity of the participant tag 1602 and the item tag 1606, as here indicated by the distance 1620. For example, each of the participant tag 1602 and the item tag 1606 is a wireless device communicating using one or more wireless protocols. The range of wireless communications from either the participant tag 1602 or the item tag 1606 may depend on multiple factors, including, but not limited to, the type of wireless equipment (e.g., kind(s) of transmitter, receiver, or transceiver used), operational status, power supply, interference, obstructions, weather, atmospheric conditions, and the like.

The distance 1620 can represent a situation where the participant tag 1602 and the item tag 1606 are within range of each other, to name just one example. Each of the participant tag 1602 and the item tag 1606 can transmit a corresponding beacon that can be observed by any wireless receivers that are within range of the tag. The term beacon is here being used to refer to the wireless (e.g., radio) signal that is being transmitted. The beacon can include one or more unique identifiers that may be associated with the tag that transmits the beacon. The beaconing of either the participant tag 1602 or the item tag 1606, or both, can be performed continuously, at regular intervals, or randomly, over a shorter or longer period of time, to name just a few examples.

When the participant tag 1602 and the item tag 1606 are within range, they can receive each other's beacon(s). In some implementations, the beacon of at least one of the tags includes unencrypted (e.g., plaintext) information. The beacon may include the session token 1616. For example, including the session token 1616 in the beacon may be advantageous in that it can help the other tag(s) involved in the arrangement identify the beacon for purposes of connecting with the originating tag. In some implementations, the beacon of at least one of the tags includes encrypted information. For example, either of the participant tag 1602 or the item tag 1606, or both, may encrypt the beacon using the public key of the other tag. This facilitates that the other tag can decrypt the beacon using its corresponding key. By identifying the correct other tag using the session token 1616 in the corresponding received beacon, each of the participant tag 1602 and the item tag 1606 can establish connection with the other.

The participant tag 1602 and the item tag 1606 can exchange one or more keys with each other for purposes of establishing secure connection. FIG. 16D shows an example of exchanging certificates. The described exchanges may occur simultaneously, or in any respective order. The participant tag 1602 has provided the security certificate 1618 (e.g., the public key of the item tag 1606) to the item tag 1606. Accordingly, the item tag 1606 currently has access to (at least) the security certificate 1618 of the participant tag 1602, and its own security certificate (e.g., the private key of the item tag 1606). For example, the item tag 1606 can establish an encryption key using at least this information, and use the encryption key for secure communication with the participant tag 1602. That is, the item tag 1606 can use the described exchange(s) to verify that the participant tag 1602 is the tag of the participant who made the arrangement in the arrangement process 1608, which arrangement is uniquely associated with the session token 1616.

The item tag 1606 has provided the security certificate 1614 (e.g., the public key of the participant tag 1602) to the participant tag 1602. Accordingly, the participant tag 1602 currently has access to (at least) the security certificate 1614 of the item tag 1606, and its own security certificate (e.g., the private key of the participant tag 1602). For example, the participant tag 1602 can establish an encryption key using at least this information, and use the encryption key for secure communication with the item tag 1606. That is, the participant tag 1602 can use the described exchange(s) to verify that the item tag 1606 is the tag of the item that was selected for the arrangement in the arrangement process 1608, which arrangement is uniquely associated with the session token 1616.

The above examples illustrate that receiving the security certificate of the other tag, and the session token 1616, can include: the participant tag 1602 receiving an encrypted communication from the item tag 1606, or vice versa; the participant tag 1602 decrypting the encrypted communication using the security certificate of the item tag 1606, or vice versa; and the participant tag 1602 or the item tag 1606 determining that the encrypted communication includes the session token 1616.

FIG. 16E shows an example where either of the participant tag 1602 or the item tag 1606, or both, can determine a distance 1622 between the participant tag 1602 and the item tag 1606. In some implementations, a proximity criterion can be established by the participant tag 1602, the item tag 1606, the arrangement broker system 1604, or another entity. The proximity criterion can define a greatest separation between the participant tag 1602 and the item tag 1606 at which either or both of the participant tag 1602 and the item tag 1606 can verify the presence and identity of the other device. In a public or semi-public location, for example, an item with which the item tag 1606 is associated may be one of multiple items that are currently near the participant tag 1602. Accordingly, while the wireless range of the participant tag 1602 and the item tag 1606 may permit verification at a distance greater than the proximity criterion, the proximity criterion can be imposed for additional certainty in the verification. In some implementations, the proximity criterion is satisfied when the participant tag 1602 and the item tag 1606 are within range of each other.

The participant tag 1602 can engage in one or more communications 1624 with the arrangement broker system 1604 regarding its verification. For example, the communication 1624 can provide the session token 1616 and inform the arrangement broker system 1604 that the participant tag 1602 has verified the presence and identity of the item tag 1606 for the arrangement. The arrangement broker system 1604 can, by way of the communication 1624, provide an acknowledgement to the participant tag 1602 that the session token 1616 is the identifier for the arrangement of the participant. For example, this can provide the participant carrying the participant tag 1602 an additional level of confidence that the arrangement broker system 1604—the entity with which the participant interacted regarding the arrangement—also acknowledges that the participant has identified the correct item (i.e., the item associated with the item tag 1606) for the arrangement.

The item tag 1606 can engage in one or more communications 1626 with the arrangement broker system 1604 regarding its verification. For example, the communication 1626 can provide the session token 1616 and inform the arrangement broker system 1604 that the item tag 1606 has verified the presence and identity of the participant tag 1602 for the arrangement. The arrangement broker system 1604 can, by way of the communication 1626, provide an acknowledgement to the item tag 1606 that the session token 1616 is the identifier of the arrangement with which the item is associated. For example, this can provide an additional level of confidence that the arrangement broker system 1604—the entity by which the item was selected regarding the arrangement—also acknowledges that the item has identified the correct participant (i.e., the custodian of the participant tag 1602) for the arrangement.

Either the participant tag 1602 or the item tag 1606, or both, can perform a multi-factor verification of the other. In some implementations, an auxiliary component 1628 is also associated with the arrangement. The auxiliary component 1628 may be a piece of equipment involved in, or otherwise associated with, the arrangement. When the participant interacts with the arrangement broker system 1604 regarding the arrangement, the arrangement broker system 1604 can provide the identifier for the auxiliary component 1628 to the participant tag 1602 and/or to the item tag 1606. The auxiliary component 1628 can be a tag equivalent to the participant tag 1602 or the item tag 1606, or both, or the auxiliary component 1628 can be another wireless component or device (e.g., an NFC component of a vehicle or other equipment). One or more communications 1630 between the auxiliary component 1628 and, in this example, the participant tag 1602, can be performed similarly to the above-described exchange of certificates between the participant tag 1602 and the item tag 1606. As another example, the communications 1630 can involve the participant tag 1602 detecting a standard identifier that the auxiliary component 1628 beacons in the ordinary course of its operation. Accordingly, the detection by the participant tag 1602 of an identifier from the auxiliary component 1628, by the one or more communications 1630, can provide the participant additional verification that the other participant is the correct one, and that the correct equipment is present. In some implementations, the communication 1630 can instead or in addition occur between the auxiliary component 1628 and the item tag 1606. For example, the auxiliary component can be associated with the participant of the participant tag 1602 and this can provide additional verification that the participant is the correct one to be grated access to the item.

One or more of the participant tag 1602 and the item tag 1606 can provide a communication to the other. For example, the participant tag 1602 can confirm to the item tag 1606 that the participant tag 1602 has identified the presence and identity of the item tag 1606. As another example, the item tag 1606 can confirm to the participant tag 1602 that the item tag 1606 has identified the presence and identity of the participant tag 1602. Either or both of such confirmations can serve as a confirmation of the arrangement.

One or more of the participant tag 1602 and the item tag 1606 can provide an output regarding the verification(s) of presence and identity of the other. FIG. 16F shows an example where a verification 1632 is output using a user interface 1634 (labeled UI) of the participant tag 1602. For example, this can provide the participant who is the custodian of the participant tag 1602 an assurance that the participant tag 1602 has identified the presence and identity of the item tag 1606. As another example, a verification 1636 is output using a user interface 1638 of the item tag 1606. For example, this can provide an assurance that the item tag 1606 has identified the presence and identity of the participant tag 1602.

The above examples illustrate that a method can include receiving, in the item tag 1606 and from the arrangement broker system 1604, the security certificate 1618 for the participant tag 1602 and the session token 1616 corresponding to the arrangement. The method can include determining, by the item tag 1606, that the participant tag 1602 satisfies a proximity criterion (e.g., the distance 1622) with regard to the item tag 1606; receiving, in the item tag 1606 and from the participant tag 1602, the security certificate 1618 and the session token 1616; and generating, by the item tag 1606 and in response to the determination and the receipt of the security certificate 1618 and the session token 1616, the verification 1636 that verifies the custodian of the participant tag 1602 as participant in the arrangement.

Performing presence and identity verification by way of the participant tag 1602 and the item tag 1606 can provide one or more advantages. In some implementations, the participant tag 1602 and the item tag 1606 seamlessly perform the presence and identity verification without prompting or input by the corresponding custodian. As such, the custodian may not need to manipulate any device to perform the verification; rather, when the proximity is sufficient and the security certificate and session token check out, the user may simply notice that the corresponding participant tag 1602 or the item tag 1606 outputs a verification to confirm the presence and identity.

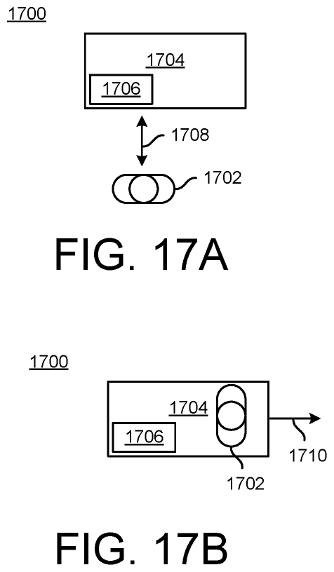

FIGS. 17A-B show other examples relating to presence and identity verification regarding an item. The examples are described with reference to a system 1700 that can be used with one or more other examples described elsewhere herein. The system 1700, or individual components thereof, can be implemented using one or more examples described herein with reference to FIG. 18.

FIG. 17A shows that a person 1702 and an item 1704 are present near each other.

The person 1702 is the custodian of a tag that has previously engaged in a pre-authorization process (e.g., as shown in FIG. 16B) regarding an arrangement with the item 1704. The pre-authorization process may have resulted in information (e.g., one or more security certificates, session tokens, and/or cryptography keys) being provided to the tag of the person 1702 and/or to a tag 1706 of the item 1704. In some implementations, the tag of the person 1702 and/or the tag 1706 is configured to have its presence, proximity, and movement be managed by at least one other component (e.g., another tag, a parent tag, a hub, or another processing device). In some implementations, the tag of the person 1702 and/or the tag 1706 is configured to manage the presence, proximity, and movement of at least one other component (e.g., another tag, such as a child tag).

The situation depicted in FIG. 17A can occur subsequent to the pre-authorization process. Here, at least one communication 1708 takes place between the tag of the person 1702 and/or the tag 1706. That is, the person 1702 now seeks to gain access to the item 1704 according to the arrangement. At one or more points in time, the tag of the person 1702 and the tag 1706 may physically be near each other. A verification of presence and identity can then be performed. For example, the identity component 315 (FIG. 3) can be used. For example, each of the tag of the person 1702 and the tag 1706 has a wireless device communicating using one or more wireless protocols. The range of wireless communications from either the tag of the person 1702 and the tag 1706 may depend on multiple factors, including, but not limited to, the type of wireless equipment (e.g., kind(s) of transmitter, receiver, or transceiver used), operational status, power supply, interference, obstructions, weather, atmospheric conditions, and the like.

When the tag of the person 1702 and the tag 1706 are within range, they can receive each other's beacon(s). In some implementations, the beacon of at least one of the tags includes unencrypted (e.g., plaintext) information. The beacon may include the session token. For example, including the session token in the beacon may be advantageous in that it can help the other tag(s) involved in the arrangement identify the beacon for purposes of connecting with the originating tag. In some implementations, the beacon of at least one of the tags includes encrypted information. For example, either of the tag of the person 1702 and the tag 1706, or both, may encrypt the beacon using the public key of the other tag. This facilitates that the other tag can decrypt the beacon using its corresponding key. By identifying the correct other tag using the session token in the corresponding received beacon, each of the tag of the person 1702 and the tag 1706 can establish connection with the other.

The tag of the person 1702 and the tag 1706 can exchange one or more keys with each other for purposes of establishing secure connection. The described exchanges may occur simultaneously, or in any respective order. The tag of the person 1702 can provide the security certificate (e.g., the public key of the tag of the person 1702) to the tag 1706. Accordingly, the tag 1706 currently has access to (at least) the security certificate of the tag of the person 1702, and its own security certificate (e.g., the private key of the tag 1706). For example, the tag 1706 can establish an encryption key using at least this information, and use the encryption key for secure communication with the tag of the person 1702. That is, the tag 1706 can use the described exchange(s) to verify that the person 1702 is the participant of the arrangement.

Upon verification by at least the tag 1706 of the presence and identity of the tag of the person 1702, the tag 1706 can generate an output that gives the person 1702 access to the item 1704. FIG. 17B shows an example where the person 1702 has gained access to the item 1704 and the item 1704 is being moved as schematically illustrated using an arrow 1710. For example, the tag 1706 can cause a lock on the item 1704 to be deactivated, which allows the person 1702 to move the item 1704. As another example, the tag 1706 can energize an internal motor of the item 1704 that facilitates the person 1702 to move the item 1704 by way of the motor.

FIG. 18 illustrates an example architecture of a computing device 1800 that can be used to implement aspects of the present disclosure, including any of the systems, apparatuses, and/or techniques described herein, or any other systems, apparatuses, and/or techniques that may be utilized in the various possible embodiments.

The computing device illustrated in FIG. 18 can be used to execute the operating system, application programs, and/or software modules (including the software engines) described herein.

The computing device 1800 includes, in some embodiments, at least one processing device 1802 (e.g., a processor), such as a central processing unit (CPU). A variety of processing devices are available from a variety of manufacturers, for example, Intel or Advanced Micro Devices. In this example, the computing device 1800 also includes a system memory 1804, and a system bus 1806 that couples various system components including the system memory 1804 to the processing device 1802. The system bus 1806 is one of any number of types of bus structures that can be used, including, but not limited to, a memory bus, or memory controller; a peripheral bus; and a local bus using any of a variety of bus architectures.

Examples of computing devices that can be implemented using the computing device 1800 include a desktop computer, a laptop computer, a tablet computer, a mobile computing device (such as a smart phone, a touchpad mobile digital device, or other mobile devices), or other devices configured to process digital instructions.

The system memory 1804 includes read only memory 1808 and random access memory 1810. A basic input/output system 1812 containing the basic routines that act to transfer information within computing device 1800, such as during start up, can be stored in the read only memory 1808.

The computing device 1800 also includes a secondary storage device 1814 in some embodiments, such as a hard disk drive, for storing digital data. The secondary storage device 1814 is connected to the system bus 1806 by a secondary storage interface 1816. The secondary storage device 1814 and its associated computer readable media provide nonvolatile and non-transitory storage of computer readable instructions (including application programs and program modules), data structures, and other data for the computing device 1800.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. For example, a computer program product can be tangibly embodied in a non-transitory storage medium. Additionally, such computer readable storage media can include local storage or cloud-based storage.

A number of program modules can be stored in secondary storage device 1814 and/or system memory 1804, including an operating system 1818, one or more application programs 1820, other program modules 1822 (such as the software engines described herein), and program data 1824. The computing device 1800 can utilize any suitable operating system, such as Microsoft Windows™, Google Chrome™ OS, Apple OS, Unix, or Linux and variants and any other operating system suitable for a computing device. Other examples can include Microsoft, Google, or Apple operating systems, or any other suitable operating system used in tablet computing devices.

In some embodiments, a user provides inputs to the computing device 1800 through one or more input devices 1826. Examples of input devices 1826 include a keyboard 1828, mouse 1830, microphone 1832 (e.g., for voice and/or other audio input), touch sensor 1834 (such as a touchpad or touch sensitive display), and gesture sensor 1835 (e.g., for gestural input. In some implementations, the input device(s) 1826 provide detection based on presence, proximity, and/or motion. In some implementations, a user may walk into their home, and this may trigger an input into a processing device. For example, the input device(s) 1826 may then facilitate an automated experience for the user. Other embodiments include other input devices 1826. The input devices can be connected to the processing device 1802 through an input/output interface 1836 that is coupled to the system bus 1806. These input devices 1826 can be connected by any number of input/output interfaces, such as a parallel port, serial port, game port, or a universal serial bus. Wireless communication between input devices 1826 and the input/output interface 1836 is possible as well, and includes infrared, BLUETOOTH® wireless technology, 802.11a/b/g/n, cellular, ultra-wideband (UWB), ZigBee, or other radio frequency communication systems in some possible embodiments, to name just a few examples.

In this example embodiment, a display device 1838, such as a monitor, liquid crystal display device, projector, or touch sensitive display device, is also connected to the system bus 1806 via an interface, such as a video adapter 1840. In addition to the display device 1838, the computing device 1800 can include various other peripheral devices (not shown), such as speakers or a printer.

The computing device 1800 can be connected to one or more networks through a network interface 1842. The network interface 1842 can provide for wired and/or wireless communication. In some implementations, the network interface 1842 can include one or more antennas for transmitting and/or receiving wireless signals. When used in a local area networking environment or a wide area networking environment (such as the Internet), the network interface 1842 can include an Ethernet interface. Other possible embodiments use other communication devices. For example, some embodiments of the computing device 1800 include a modem for communicating across the network.

The computing device 1800 can include at least some form of computer readable media. Computer readable media includes any available media that can be accessed by the computing device 1800. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 1800.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 18 is also an example of programmable electronics, which may include one or more such computing devices, and when multiple computing devices are included, such computing devices can be coupled together with a suitable data communication network so as to collectively perform the various functions, methods, or operations disclosed herein.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A method comprising:
receiving, in a first tag, a first security certificate for a second tag and a session token corresponding to an arrangement involving the first and second tags;
determining, by the first tag, that the second tag satisfies a proximity criterion with regard to the first tag;
receiving, in the first tag and from the second tag, the first security certificate and the session token; and
generating, by the first tag and in response to the determination and the receipt of the first security certificate and the session token, a first output corresponding to verification of a custodian of the second tag as a participant in the arrangement.

2. The method of claim 1, wherein receiving the first security certificate and the session token from the second tag comprises:
receiving, by the first tag and from the second tag, an encrypted communication;
decrypting, by the first tag, the encrypted communication using the first security certificate; and
determining, by the first tag, that the encrypted communication includes the session token.

3. The method of claim 2, wherein the first security certificate is received from an arrangement broker system.

4. The method of claim 3, wherein a first person associated with the first tag makes the arrangement using an online interface provided by the arrangement broker system.

5. The method of claim 4, wherein the arrangement broker system provides the first security certificate and the session token to the first tag upon the arrangement being made.

6. The method of claim 3, further comprising providing, by the first tag and to the arrangement broker system, a second security certificate for the first tag.

7. The method of claim 3, wherein the arrangement broker system comprises a service broker system.

8. The method of claim 7, wherein the arrangement comprises that a first person associated with the first tag makes a reservation for an O2O service using an online interface provided by the arrangement broker system.

9. The method of claim 8, wherein the O2O service includes a rideshare arrangement where a second person associated with the second tag is to use a vehicle to transport the first person.

10. The method of claim 9, further comprising determining, by the first tag and after generating the first output, that the second tag no longer satisfies the proximity criterion with regard to the first tag without the O2O service being complete, and in response generating a second output.

11. The method of claim 9, further comprising verifying, by the first tag, a passenger that is in the vehicle when the first security certificate and the session token are received.

12. The method of claim 11, wherein verifying the passenger comprises:
receiving, by the first tag and from the service broker system, a first passenger token;
receiving, by the first tag and in association with receiving the first security certificate and the session token, a second passenger token from a third tag; and
determining, by the first tag, a correspondence between the first passenger token and the second passenger token.

13. The method of claim 3, further comprising, providing, by the first tag and after receiving the first security certificate and the session token, the session token to the arrangement broker system.

14. The method of claim 3, wherein a multifactor authentication is performed, the multifactor authentication comprising:
receiving, by the first tag and in association with the arrangement being made, a first authentication token from the arrangement broker system;
receiving, by the first tag and in association with receiving the first security certificate and the session token, a second authentication token from a third tag; and
determining, by the first tag, a correspondence between the first authentication token and the second authentication token.

15. The method of claim 14, wherein the arrangement involves a rideshare service in which the third tag is carried by a vehicle.

16. The method of claim 15, wherein the second authentication token is native to the vehicle.

17. The method of claim 15, wherein the second authentication token is specific to the rideshare service and was provided to the vehicle by the arrangement broker system.

18. The method of claim 1, further comprising generating, by the first tag, a communication to the second tag that confirms the arrangement.

19. The method of claim 1, wherein the session token includes a secured, single-use, digitally signed token.

20. The method of claim 1, wherein the arrangement includes that a second person associated with the second tag is to enter premises of a first person, a lock to the premises associated with the first tag.

21. The method of claim 20, further comprising a pre-authorization process comprising:
the first security certificate being received by a device carried by the first person; and
the first tag receiving the first security certificate from the device.

22. The method of claim 21, wherein receipt of the first security certificate by the device occurs in a first context when the device does not have online access, and wherein receipt of the first security certificate by the first tag occurs in a second context when the device does have the online access.

23. A computer program product tangibly embodied in a non-transitory storage medium, the computer program product including instructions that when executed cause a processor to perform operations, the operations comprising:
receiving, in a first tag, a first security certificate for a second tag and a session token corresponding to an arrangement involving the first and second tags;
determining, by the first tag, that the second tag satisfies a proximity criterion with regard to the first tag;
receiving, in the first tag and from the second tag, the first security certificate and the session token; and
generating, by the first tag and in response to the determination and the receipt of the first security certificate and the session token, a first output corresponding to verification of a custodian of the second tag as a participant in the arrangement.

24. A method comprising:
receiving, in an arrangement broker system and from a first tag associated with a first person, a first security certificate for the first tag, the first security certificate received in association with an arrangement involving the first person;
identifying, by the arrangement broker system, a second tag associated with a second person also involved with the arrangement;
generating, by the arrangement broker system, a session token for the arrangement; and
providing, by the arrangement broker system and to the second tag, the first security certificate and the session token.

25. The method of claim 24, further comprising receiving, by the arrangement broker system and from at least one of the first tag or the second tag, a communication that includes the session token.
